(19) United States
(12) Patent Application Publication
(10) Pub. No.: US 2025/0358597 A1
(43) Pub. Date: Nov. 20, 2025

(54) COMMUNICATION SYSTEMS, APPARATUSES, METHODS, AND NON-TRANSITORY COMPUTER-READABLE STORAGE DEVICES FOR INTEGRATED SENSING AND COMMUNICATION USING COOPERATIVE SENSING

(71) Applicant: Huawei Technologies Co., Ltd., Shenzhen (CN)

(72) Inventors: Hao Tang, Ottawa (CA); Jianglei Ma, Ottawa (CA); Peiying Zhu, Kanata (CA); Yan Chen, Ottawa (CA)

(21) Appl. No.: 19/287,490

(22) Filed: Jul. 31, 2025

Related U.S. Application Data
(63) Continuation of application No. PCT/CN2023/124462, filed on Oct. 13, 2023.
(60) Provisional application No. 63/463,663, filed on May 3, 2023.

(51) Int. Cl. H04W 4/38; H04J 13/00; H04W 16/28; H04W 48/20; H04W 52/52

(52) U.S. Cl. CPC H04W 4/38; H04J 13/0062; H04W 16/28; H04W 48/20; H04W 52/52

(57) ABSTRACT

Communication systems, apparatuses, methods, and one or more non-transitory computer-readable storage devices for cooperative sensing in integrated communication and sensing employs the steps of: determining a type of a first communication node for object sensing, and notifying the first communication node the determined type. Said determining the type of the first communication node has the steps of: determining the type of the first communication node as a sensing transceiving node in a sensing transceiving set to receive or transmit a sensing signal for object sensing, or determining the type of the first communication node as a sensing active node in a sensing active set, the sensing active set comprising the sensing transceiving set.

### CROSS-REFERENCE TO RELATED APPLICATIONS

This application is a continuation of International Application No. PCT/CN2023/124462, filed on Oct. 13, 2023, which claims the benefit of U.S. Provisional Patent Application Ser. No. 63/463,663, filed May 3, 2023, the content of which is incorporated herein by reference in its entirety.

### TECHNICAL FIELD

The present disclosure relates generally to communication systems, apparatuses, methods, and non-transitory computer-readable storage devices, and in particular to communication systems, apparatuses, methods, and non-transitory computer-readable storage devices for integrated sensing and communication using cooperative sensing.

### BACKGROUND

Mobile communication systems are known. In mobile communications, the communication system or communication devices thereof often need to or prefer to understand the environment. For example, a communication device may need to know the direct or even the location of the other device that it is communicating therewith, so as to steer a radio-frequency (RF) beam towards the other device for better signal transmission and/or receiving. As another example, an object between two devices in communication may obstruct the direct propagation path between the two communication devices, thereby causing negative impact to the communication between the two communication devices. It may be preferable to sense such objects to allow the communication devices to take necessary actions to alleviate or even eliminate such negative impacts.

Therefore, next generation mobile communication systems may include sensing technologies for various uses and benefits.

### SUMMARY

Embodiments of this disclosure relate to communication systems, apparatuses, methods, and one or more non-transitory computer-readable storage devices for integrated sensing and communication using cooperative sensing.

According to one aspect of this disclosure, there is provided a first method comprising: determining a type of a first communication node for object sensing; and notifying the first communication node the determined type; said determining the type of the first communication node comprises: determining the type of the first communication node as a sensing transceiving node in a sensing transceiving set to receive or transmit a sensing signal for object sensing, or determining the type of the first communication node as a sensing active node in a sensing active set, the sensing active set comprising the sensing transceiving set.

In some embodiments of the first method, said determining the type of the first communication node comprises: determining the type of the first communication node as the sensing transceiving node in the sensing transceiving set; determining the type of the first communication node as the sensing active node in the sensing active set; or determining the type of the first communication node as a sensing cooperative node in a sensing cooperative set, the sensing cooperative set comprising the sensing active set.

In some embodiments of the first method, the first communication node is the sensing cooperating node; and said determining the type of the first communication node comprises: activating the first communication node to become the sensing active node.

In some embodiments of the first method, the first communication node is the sensing active node, and said determining the type of the first communication node comprises: deactivating the first communication node to become the sensing cooperating node.

In some embodiments of the first method, the first communication node is the sensing active node; and said determining the type of the first communication node comprises: determining the type of the first communication node as the sensing transceiving node in the sensing transceiving set based on an instruction of a transmit-and-receive point (TRP).

In some embodiments of the first method, the first communication node is the sensing active node; and said determining the type of the first communication node comprises: determining, based information of a measurement of a sensing reference signal, the type of the first communication node as the sensing transceiving node in the sensing transceiving set.

In some embodiments of the first method, the sensing reference signal comprising one or more automatic gain control (AGC) symbols.

In some embodiments of the first method, the measurement of the sensing reference signal comprises a power measurement of the sensing reference signal.

In some embodiments of the first method, said determining the type of the first communication node further comprises: transmitting the sensing reference signal to the first communication node; and receiving the information of the measurement of the sensing reference signal from the first communication node.

In some embodiments of the first method, said determining the type of the first communication node further comprises: receiving the sensing reference signal to the first communication node; and determining the information of the measurement of the sensing reference signal.

In some embodiments of the first method, said determining, based on the information of the measurement of the sensing reference signal, the type of the first communication node as the sensing transceiving node in the sensing transceiving set comprises: determining the type of the first communication node as the sensing transceiving node in the sensing transceiving set if the power measurement of the sensing reference signal is greater than a power threshold.

In some embodiments of the first method, said determining, based on the information of the measurement of the sensing reference signal, the type of the first communication node as the sensing transceiving node in the sensing transceiving set comprises: determining the type of the first communication node as the sensing transceiving node in the sensing transceiving set if the information of the measurement of the sensing reference signal comprises an indication of detection.

In some embodiments of the first method, the first method further comprises: transmitting a sensing signal, the sensing signal comprising a plurality of beams directing towards different directions; said transmitting the sensing signal comprises: transmitting the plurality of beams at different time slots of a time window.

In some embodiments of the first method, the first method further comprises: determining, from the plurality of beams, one or more beams that the first communication node is capable to receive; and sending the first communication node a notification regarding the determined one or more beams.

According to one aspect of this disclosure, there is provided one or more circuits (such as one or more processing units, or one or more processors) for performing the above-described first method.

According to one aspect of this disclosure, there is provided one or more non-transitory computer-readable storage devices comprising computer-executable instructions, wherein the instructions, when executed, cause one or more circuits (such as one or more processing units, or one or more processors) to perform the above-described first method.

According to one aspect of this disclosure, there is provided a second method comprising: receiving a plurality of signal beams transmitted from a transmitter (Tx) node; measuring the received plurality of signal beams to obtain measurement results of the received plurality of signal beams; and reporting, based on the measurement results, beam information and/or the measurement results of at least one of the received plurality of signal beams.

In some embodiments of the second method, the beam information of the at least subset of the received plurality of signal beams comprises time information of the at least one of the received plurality of signal beams.

In some embodiments of the second method, the time information of the at least one of the received plurality of signal beams comprises at least one of: a time slot of each of the at least one of the received plurality of signal beams; one or more symbol indices of one or more sensing symbols of each of the at least one of the received plurality of signal beams; a beam index of each of the at least one of the received plurality of signal beams; and a sequence number of each of the at least one of the received plurality of signal beams.

In some embodiments of the second method, said reporting, based on the measurement results, the beam information and/or the measurement results of the at least one of the received plurality of signal beams comprises: reporting the beam information and/or the measurement results of the at least one of the received plurality of signal beams having measured power greater than a power threshold.

In some embodiments of the second method, the second method further comprises: receiving indications of a sensing resource and a feedback resource associated with the Tx node; said receiving the plurality of signal beams transmitted from the Tx node comprises: receiving the plurality of signal beams transmitted from the Tx node using the sensing resource; and said reporting, based on the measurement results, the beam information and/or the measurement results of the at least one of the received plurality of signal beams comprises: reporting, based on the measurement results, the beam information and/or the measurement results of the at least one of the received plurality of signal beams using the feedback resource.

In some embodiments of the second method, at least one of the sensing resource and the feedback resource is a resource of frequency-division multiplexing (FDM), a resource of time-division multiplexing (TDM), a resource with a unique root index in a Zadoff-Chu (ZC) sequence, a resource with a root index and a unique cyclic shift in a ZC sequence, a resource with time-domain orthogonal cover code (OCC), a frequency domain OCC, and/or a unique timing offset.

According to one aspect of this disclosure, there is provided one or more circuits (such as one or more processing units, or one or more processors) for performing the above-described second method.

According to one aspect of this disclosure, there is provided one or more non-transitory computer-readable storage devices comprising computer-executable instructions, wherein the instructions, when executed, cause one or more circuits (such as one or more processing units, or one or more processors) to perform the above-described second method.

The technical features and benefits of the communication systems, apparatuses, methods, and one or more non-transitory computer-readable storage devices disclosed herein in various embodiments may include, but are not limited to:
By partitioning the Rx and/or Tx nodes to various cooperating sets, and by using the sensing transceiving set, only a subset of Rx nodes perform measurement and report the measurements to the Tx node, thereby reducing the air interface overhead compared to the embodiments wherein all nodes participate the cooperative sensing procedure.
By transmitting from the Tx node to the Rx nodes in the sensing active set a sensing reference signal comprising one or more automatic gain control (AGC) symbols, both AGC setting and cooperation node discovery may be achieved.
By allowing Rx nodes selectively reporting the sensing measurement information (such as the power of the received echo signals), Rx nodes may use the on-demand cooperative sensing report method to only report the information regarding the echo signals or echo signal beams it has received and does not need to report the information regarding all SAC signals or SAC signal beams. The Rx nodes may use a receiving power threshold for determining which echo signals/beams shall be reported and which shall not.
By using a sensing burst set of Tx sensing beams and by reporting from a Rx node the time locations of received echoes (for example, corresponding to Tx beam indices), the Tx node may obtain the time locations of the sensing measurements reported from the Rx node, and derive the correct sensing results.
By using distributed sensing cooperation, a Rx node may facilitate a plurality of Tx nodes in their sensing.
By allocating orthogonal sensing resources and feedback resources in distributed sensing cooperation, collision may be avoided. The use of timing offsets in feedback further ensures collision avoidance.
By using candidate Rx beams, latency and/or air interface overhead may be reduced.

### BRIEF DESCRIPTION OF THE DRAWINGS

FIGS. 1A and 1B are simplified schematic diagrams showing the structure of a communication system, according to some embodiments of this disclosure;

FIG. 2A is a simplified schematic diagram showing a user equipment (UE), a terrestrial transmit-and-receive point (T-TRP), and a non-terrestrial transmit-and-receive point (NT-TRP) of the communication system shown in FIG. 1A;

FIG. 2B is a simplified schematic diagram showing units or modules in a device, such as in UE or in TRP of the communication system shown in FIG. 1A;

FIG. 3 is a simplified schematic diagrams showing the structure of the communication system shown in FIG. 1A for integrated sensing and communication (ISAC) using a plurality of sensing and communication (SAC) nodes, according to some embodiments of this disclosure;

FIG. 4 is a simplified schematic diagram showing a sensing management function (SMF) of the communication system shown in FIG. 1A, implemented as a physically independent entity;

FIG. 5A is a schematic diagram showing an example of a cooperative sensing method performed by a transmitter (Tx) node and a receiver (Rx) node of the communication system shown in FIG. 1A, according to some embodiments of this disclosure;

FIG. 5B is a schematic diagram showing another example, where a Tx node is cooperating with two Rx nodes to sense an object, according to some embodiments of this disclosure;

FIG. 6A is a frequency-time diagram showing an example of a sensing and communication (SAC) signal transmitted between a Tx node and a Rx node of the communication system shown in FIG. 1A, according to some embodiments of this disclosure, wherein a plurality of communication symbols and a plurality of sensing symbols are multiplexed in time using a time-division multiplexing (TDM) method;

FIG. 6B is a frequency-time diagram showing an example of a SAC signal transmitted between a Tx node and a Rx node of the communication system shown in FIG. 1A, according to some embodiments of this disclosure, wherein a plurality of communication symbols and a plurality of sensing symbols are multiplexed in time using a frequency-division multiplexing (FDM) method;

FIG. 6C is a frequency-time diagram showing an example of a SAC signal transmitted between a Tx node and a Rx node of the communication system shown in FIG. 1A, according to some embodiments of this disclosure, wherein a plurality of communication symbols and a plurality of sensing symbols are multiplexed in both frequency and time using a TDM/FDM method, such that each of a first and a second frequency bands transmits a mixture of communication symbols and sensing symbols multiplexed in time;

FIG. 7 is a frequency-time diagram showing an exemplary chirp signal used by the communication system shown in FIG. 1A for sensing;

FIG. 8A shows a sensing symbol having one chirp signal, according to some embodiments of this disclosure;

FIG. 8B shows a sensing symbol having two chirp signals multiplexed in frequency, according to some embodiments of this disclosure;

FIG. 8C shows a sensing symbol having two chirp signals multiplexed in time, according to some embodiments of this disclosure;

FIG. 8D shows a sensing symbol having four chirp signals multiplexed in frequency and time, according to some embodiments of this disclosure;

FIG. 9 is a frequency-time diagram showing an example of a SAC signal using OFDM symbols as the communication symbols, according to some embodiments of this disclosure;

FIG. 10 is a schematic diagram showing the classification of receiver (Rx) nodes of the communication system shown in FIG. 1A into various cooperating sets, according to some embodiments of this disclosure;

FIG. 11 is a flowchart showing a sensing-transceiving determination procedure performed by a transmitter (Tx) node of the communication system shown in FIG. 1A, according to some embodiments of this disclosure;

FIG. 12 is a schematic diagram showing an example of the sensing-transceiving determination procedure shown in FIG. 11;

FIG. 13 is a schematic diagram showing an example of a SAC signal in the form of sensing burst set and comprising four sensing beams transmitted by a Tx node of the communication system shown in FIG. 1A at different time slots of a time window towards a plurality of directions for covering a wide angular span;

FIG. 14 is a schematic diagram showing an example wherein a Rx node of the communication system shown in FIG. 1A may only receive the echoes of a subset of the sensing beams transmitted by a Tx node of the communication system shown in FIG. 1A;

FIG. 15 is a flowchart showing an on-demand cooperative sensing reporting procedure executed by a Rx node of the communication system shown in FIG. 1A for on-demanding cooperative sensing reporting, according to some embodiments of this disclosure;

FIG. 16 is a flowchart showing an on-demand cooperative sensing reporting procedure executed by a Rx node of the communication system shown in FIG. 1A for on-demanding cooperative sensing reporting, according to some other embodiments of this disclosure;

FIG. 17 is a flowchart showing a distributed sensing cooperation procedure executed by a cooperating Rx node of the communication system shown in FIG. 1A, according to some embodiments of this disclosure;

FIG. 18 is a schematic diagram showing an example of the distributed sensing cooperation;

FIG. 19 is a schematic diagram showing the conventional beam sweeping;

FIGS. 20 and 21 are schematic diagrams showing examples of using candidate receiving beams in the communication system shown in FIG. 1A to alleviate beam sweeping, according to some embodiments of this disclosure; and

FIG. 22 is a schematic diagram showing a plurality of Tx nodes cooperating with a Rx node for sensing, according to some embodiments of this disclosure.

### DETAILED DESCRIPTION OF ILLUSTRATIVE EMBODIMENTS

### A. System Structure

### A-1. General System Structure

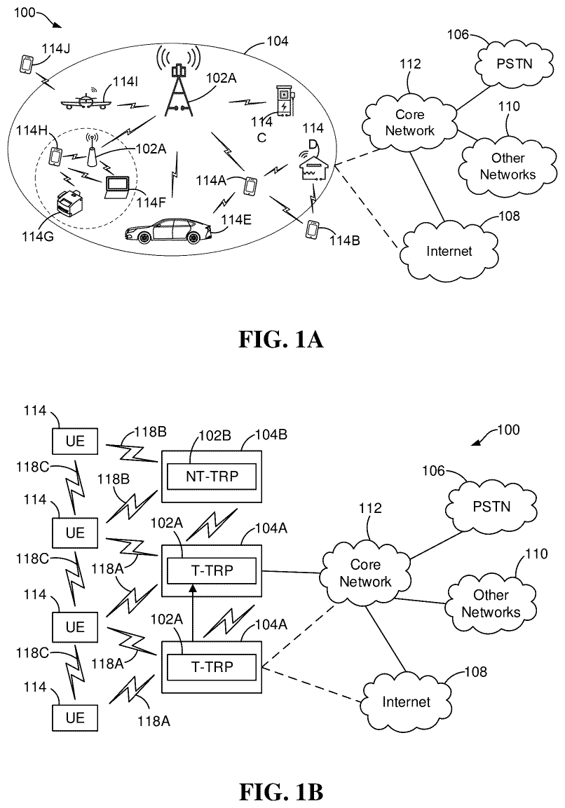

Referring to FIG. 1A, as an illustrative example without limitation, a simplified schematic illustration of a communication system is provided. The communication system 100 comprises a radio access network (RAN) 104. The RAN 104 may be a next generation (for example, sixth generation (6G) or later) RAN, or a legacy (for example, fifth-generation (5G), fourth-generation (4G), third-generation (3G), or second-generation (2G)) RAN. One or more user equipments (UEs) 114A to 114J (generically referred to as 114) may be interconnected to one another or connected to one or more network nodes 102A in the RAN 104. A core network 112 may be a part of the communication system and may be dependent or independent of the radio access technology used in the communication system 100. Also the communication system 100 comprises a public switched telephone network (PSTN) 106, the internet 108, and other networks 110.

FIG. 1B illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, and unicast, and/or the like. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, and/or the like). The communication system 100 may provide a high degree of availability and robustness through a joint operation of the terrestrial communication system and the non-terrestrial communication system. For example, integrating a non-terrestrial communication system (or components thereof) into a terrestrial communication system may result in what may be considered a heterogeneous network comprising multiple layers. As those skilled in the art will appreciate, the heterogeneous network may achieve improved overall performance through efficient multi-link joint operation, more flexible functionality sharing, and faster physical layer link switching between terrestrial networks and non-terrestrial networks.

The terrestrial communication system and the non-terrestrial communication system may be considered sub-systems of the communication system 100. In the example shown, the communication system 100 includes UEs 114, RANs 104A (also called “terrestrial communication networks”), non-terrestrial communication networks 104B, a core network 112, a public switched telephone network (PSTN) 106, the internet 108, and other networks 110. The RANs 104A include respective base stations (BSs) 102A, which may be generically referred to as terrestrial transmit-and-receive points (T-TRPs) 102A. The non-terrestrial communication network 104B includes an access node 102B, which may be generically referred to as a non-terrestrial transmit-and-receive point (NT-TRP) 102B. The T-TRPs 102A and the NT-TRP 102B may be generally referred to as TRPs or access nodes 102.

Any UE 114 may be alternatively or additionally configured to interface, access, or communicate with any other T-TRP 102A and NT-TRP 102B, the internet 108, the core network 112, the PSTN 106, the other networks 110, or any combination of the preceding. In some examples, UE 114 may communicate an uplink (UL) and/or downlink (DL) transmission over a terrestrial interface 118A with T-TRP 102A. In some examples, A UE 114 may communicate a UL and/or DL transmission over a non-terrestrial interface 118B with NT-TRP 102B. In some examples, the UEs 114 may also communicate directly with one another via one or more sidelink air interfaces 118C.

The air interfaces 118A and 118C may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA; also known as discrete Fourier transform spread OFDMA, DFT-s-OFDMA) in the air interfaces 118A and 118C. The air interfaces 118A and 118C may utilize other higher dimension signal spaces, which may involve a combination of orthogonal and/or non-orthogonal dimensions.

The non-terrestrial air interface 118B may enable communication between a UE 114 and one or multiple NT-TRPs 102B via a wireless link or simply a link. For some examples, the link is a dedicated connection for unicast transmission, a connection for broadcast transmission, or a connection between a group of UEs 114 and one or multiple NT-TRPs 102B for multicast transmission.

The RANs 104A are in communication with the core network 112 to provide the UEs 114 with various services such as voice, data, and other services. The RANs 104A and/or the core network 112 may be in direct or indirect communication with one or more other RANs (not shown), which may or may not be directly served by core network 112, and may or may not employ the same radio access technology as RANs 104A. The core network 112 may also serve as a gateway access between (i) the RANs 104A, or UEs 114, or both, and (ii) other networks (such as the PSTN 106, the internet 108, and the other networks 110). In addition, some or all of the UEs 114 may include functionality for communicating with different wireless networks over different wireless links using different wireless technologies and/or protocols. Instead of wireless communication (or in addition thereto), the UEs 114 may communicate via wired communication channels to a service provider or switch (not shown), and to the internet 108. PSTN 106 may include circuit switched telephone networks for providing plain old telephone service (POTS). Internet 108 may include a network of computers and subnets (intranets) or both, and incorporate protocols, such as internet protocol (IP), transmission control protocol (TCP), user datagram protocol (UDP). UEs 114 may be multimode devices capable of operation according to multiple radio access technologies, and incorporate multiple transceivers necessary to support such.

### A-2. Basic Component Structure

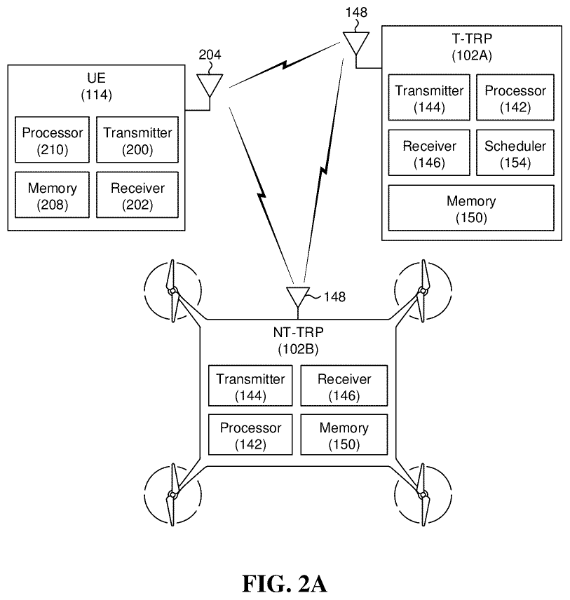

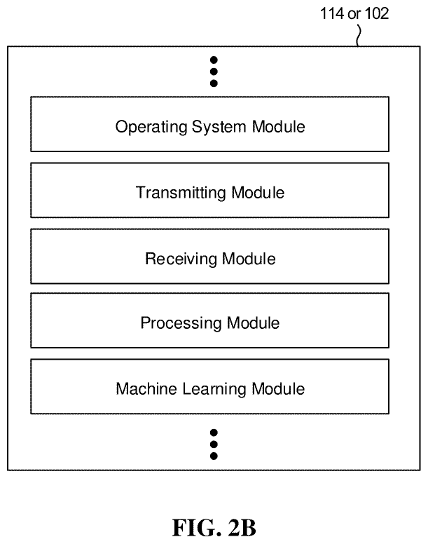

FIG. 2A illustrates an example of a UE 114, a T-TRP 102A, and a NT-TRP 102B. The UE 114 is used to connect persons, objects, machines, and/or the like. The UE 114 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, and/or the like.

Each UE 114 represents any suitable end-user device for wireless operation and may include such devices (or may be referred to) as a user device, a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, a wearable device (such as a watch, a pair of glasses, a head mounted equipment, and/or the like), an industrial device, a robot, or apparatus (for example, communication module, modem, or chip) in or comprising the forgoing devices, among other possibilities. Future generation UEs 114 may be referred to using other terms. Each UE 114 connected to T-TRP 102A and/or NT-TRP 102B may be dynamically or semi-statically turned-on (that is, established, activated, or enabled), turned-off (that is, released, deactivated, or disabled) and/or configured in response to one of more of: connection availability and connection necessity.

The T-TRP 102A may be known by other names in some implementations, such as a base station, a base transceiver station (BTS), a radio base station, a network node, a network device, a device on the network side, a transmit/receive node, a Node B, an evolved NodeB (eNodeB or eNB), a home eNodeB, a next generation NodeB (gNB), a transmission point (TP), a site controller, an access point (AP), or a wireless router, a relay station, a remote radio head, a terrestrial node, a terrestrial network device, or a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 102A may be macro BSs, pico BSs, relay node, donor node, or the like, or combinations thereof. The T-TRP 102A may refer to the forgoing devices or refer to an apparatus (for example, a communication module, a modem, a chip, or the like) in the forgoing devices.

In some embodiments, the parts of the T-TRP 102A may be distributed. For example, some of the modules of the T-TRP 102A may be located remote from the equipment housing the antennas of the T-TRP 102A, and may be coupled to the equipment housing the antennas over a communication link (not shown) sometimes known as front haul, such as common public radio interface (CPRI). Therefore, in some embodiments, the term T-TRP 102A may also refer to modules on the network side that perform processing operations, such as determining the location of the UE 114, resource allocation (scheduling), message generation, and encoding/decoding, and that are not necessarily part of the equipment housing the antennas of the T-TRP 102A. The modules may also be coupled to other T-TRPs. In some embodiments, the T-TRP 102A may actually be a plurality of T-TRPs that are operating together to serve the UE 114, for example, through coordinated multipoint transmissions.

The T-TRP 102A comprises one or more circuits (such as one or more electronic circuits and/or one or more optical circuits) forming various components. For example, the T-TRP 102 may comprise at least one transmitter 144 and at least one receiver 146 coupled to one or more antennas 148. Only one antenna 148 is illustrated. One, some, or all of the antennas may alternatively be panels. The transmitter 144 and the receiver 146 may be integrated as a transceiver. The T-TRP 102A may further comprise at least one processor 142 for performing operations including those related to: preparing a transmission for DL transmission to the UE 114, processing a UL transmission received from the UE 114, preparing a transmission for backhaul transmission to NT-TRP 102B, and processing a transmission received over backhaul from the NT-TRP 102B. Processing operations related to preparing a transmission for DL or backhaul transmission may include operations such as encoding, modulating, precoding (for example, multiple input multiple output (MIMO) precoding), transmit beamforming, and generating symbols for transmission. Processing operations related to processing received transmissions in the UL or over backhaul may include operations such as receive beamforming, and demodulating and decoding received symbols. The processor 142 may also perform operations relating to network access (for example, initial access) and/or DL synchronization, such as generating the content of synchronization signal blocks (SSBs), generating the system information, and/or the like. In some embodiments, the processor 142 also generates the indication of beam direction, for example, BAI, which may be scheduled for transmission by a scheduler 154. The processor 142 performs other network-side processing operations described herein, such as determining the location of the UE 114, determining where to deploy NT-TRP 102B, and/or the like. In some embodiments, the processor 142 may generate signaling, for example, to configure one or more parameters of the UE 114 and/or one or more parameters of the NT-TRP 102B. Any signaling generated by the processor 142 is sent by the transmitter 144. Note that “signaling”, as used herein, may alternatively be called control signaling. Dynamic signaling may be transmitted in a control channel, for example, a physical downlink control channel (PDCCH), and static or semi-static higher layer signaling may be included in a packet transmitted in a data channel, for example, in a physical downlink shared channel (PDSCH), in which case the signaling may be known as higher-layer signaling, static signaling, or semi-static signaling. Higher-layer signaling may also refer to radio resource control (RRC) protocol signaling or media access control—control element (MAC-CE) signaling.

A scheduler 154 may be coupled to the processor 142. The scheduler 154 may be included within or operated separately from the T-TRP 102A, which may schedule UL, DL, and/or backhaul transmissions, including issuing scheduling grants and/or configuring scheduling-free (for example, “configured grant”) resources. The T-TRP 102A may further comprise a memory 150 for storing information and data. The memory 150 stores instructions and data used, generated, or collected by the T-TRP 102A. For example, the memory 150 may store software instructions or modules configured to implement some or all of the functionality and/or embodiments described herein and that are executed by the processor 142.

Although not illustrated, the processor 142 may form part of the transmitter 144 and/or receiver 146. Also, although not illustrated, the processor 142 may implement the scheduler 154. Although not illustrated, the memory 150 may form part of the processor 142.

The processor 142, the scheduler 154, the processing components of the transmitter 144, and the processing components of the receiver 146 may each be implemented by the same or different one or more processors that are configured to execute instructions stored in a memory, for example, in memory 150. Alternatively, some or all of the processor 142, the scheduler 154, the processing components of the transmitter 144, and the processing components of the receiver 146 may be implemented using dedicated circuitry, such as a field-programmable gate array (FPGA), a graphical processing unit (GPU), or an application-specific integrated circuit (ASIC).

Although the NT-TRP 102B is illustrated as a drone only as an example, the NT-TRP 102B may be implemented in any suitable non-terrestrial form, such as satellites and high altitude platforms, including international mobile telecommunication base stations and unmanned aerial vehicles, for example. Also, the NT-TRP 102B may be known by other names in some implementations, such as a non-terrestrial node, a non-terrestrial network device, or a non-terrestrial base station.

The NT-TRP 102B comprises one or more circuits (such as one or more electronic circuits and/or one or more optical circuits) forming various components, and may have a similar structure as the T-TRP 102A. For example, the NT-TRP 102B may comprise a transmitter 144 and a receiver 146 coupled to one or more antennas 148. Only one antenna 148 is illustrated to avoid congestion in the drawing. One, some, or all of the antennas may alternatively be panels. The transmitter 144 and the receiver 146 may be integrated as a transceiver. The NT-TRP 102B further includes at least one processor 142 for performing operations including those related to: preparing a transmission for DL transmission to the UE 114, processing a UL transmission received from the UE 114, preparing a transmission for backhaul transmission to T-TRP 102A, and processing a transmission received over backhaul from the T-TRP 102A. Processing operations related to preparing a transmission for DL or backhaul transmission may include operations such as encoding, modulating, precoding (for example, MIMO precoding), transmit beamforming, and generating symbols for transmission. Processing operations related to processing received transmissions in the UL or over backhaul may include operations such as receive beamforming, and demodulating and decoding received symbols. In some embodiments, the processor 142 implements the transmit beamforming and/or receive beamforming based on beam direction information (for example, BAI) received from T-TRP 102A. In some embodiments, the processor 142 may generate signaling, for example, to configure one or more parameters of the UE 114. In some embodiments, the NT-TRP 102B implements physical layer processing, but does not implement higher layer functions such as functions at the medium access control (MAC) or radio link control (RLC) layer. As this is only an example, more generally, the NT-TRP 102B may implement higher layer functions in addition to physical layer processing.

The NT-TRP 102B further includes a memory 150 for storing information and data. Although not illustrated, the processor 142 may form part of the transmitter 144 and/or receiver 146. Although not illustrated, the memory 150 may form part of the processor 142.

The processor 142, the processing components of the transmitter 144, and the processing components of the receiver 146 may each be implemented by the same or different one or more processors that are configured to execute instructions stored in a memory, for example, in memory 150. Alternatively, some or all of the processor 142, the processing components of the transmitter 144, and the processing components of the receiver 146 may be implemented using dedicated circuitry, such as a programmed FPGA, a hardware accelerator (for example, a GPU or artificial intelligence (AI) accelerator), or an ASIC. In some embodiments, the NT-TRP 102B may actually be a plurality of NT-TRPs that are operating together to serve the UE 114, for example, through coordinated multipoint transmissions.

The T-TRP 102A, the NT-TRP 102B, and/or the UE 114 may include other components, but these have been omitted for the sake of clarity.

The UE 114 comprises one or more circuits (such as one or more electronic circuits and/or one or more optical circuits) forming various components. More specifically, the UE 114 includes a transmitter 200 and a receiver 202 coupled to one or more antennas 204. Only one antenna 204 is illustrated to avoid congestion in the drawing. One, some, or all of the antennas may alternatively be panels. The transmitter 200 and the receiver 202 may be integrated, for example, as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The UE 114 includes at least one memory 208. The memory 208 stores instructions and data used, generated, or collected by the UE 114. For example, the memory 208 may store software instructions or modules configured to implement some or all of the functionality and/or embodiments described herein and that are executed by at least one processing unit (for example, the at least one processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The UE 114 may further include one or more input/output devices (not shown) or interfaces (such as a wired interface to the internet 108 in FIG. 1A). The input/output devices permit interaction with a user or other devices in the network. Each input/output device includes any suitable structure for providing information to or receiving information from a user, and/or for network interface communications. Suitable structures include, for example, a speaker, a microphone, a keypad, a keyboard, a display, a touch screen, a network interface, and/or the like.

The UE 114 further includes at least one processor 210 for performing operations including those operations related to preparing a transmission for UL transmission to the T-TRP 102A and/or NT-TRP 102B, those operations related to processing DL transmissions received from the T-TRP 102A and/or NT-TRP 102B, and those operations related to processing sidelink transmission to and from another UE 114. Processing operations related to preparing a transmission for UL transmission may include operations such as encoding, modulating, transmit beamforming, and generating symbols for transmission. Processing operations related to processing DL transmissions may include operations such as receive beamforming, demodulating and decoding received symbols. Depending upon the embodiment, a DL transmission may be received by the receiver 202, possibly using receive beamforming, and the processor 210 may extract signaling from the DL transmission (for example, by detecting and/or decoding the signaling). An example of signaling may be a reference signal transmitted by the T-TRP 102A and/or NT-TRP 102B. In some embodiments, the processor 142 implements the transmit beamforming and/or the receive beamforming based on the indication of beam direction, for example, beam angle information (BAI), received from T-TRP 102. In some embodiments, the processor 210 may perform operations relating to network access (for example, initial access) and/or DL synchronization, such as operations relating to detecting a synchronization sequence, decoding and obtaining the system information, and/or the like. In some embodiments, the processor 210 may perform channel estimation, for example, using a reference signal received from the T-TRP 102A and/or NT-TRP 102B.

Although not illustrated, the processor 210 may form part of the transmitter 200 and/or part of the receiver 202. Although not illustrated, the memory 208 may form part of the processor 210.

The processor 210, the processing components of the transmitter 200, and the processing components of the receiver 202 may each be implemented by the same or different one or more processors that are configured to execute instructions stored in a memory (for example, in memory 208). Alternatively, some or all of the processor 210, the processing components of the transmitter 200, and the processing components of the receiver 202 may be implemented using dedicated circuitry, such as a programmed FPGA, an ASIC, or a hardware accelerator such as a GPU or an AI accelerator.

### A-3. Basic Module Structure

One or more steps of the embodiment methods provided herein may be performed by corresponding units or modules, according to FIG. 2B. FIG. 2B illustrates units or modules in a device, such as in a UE 114 or in a TRP 102. For example, a signal may be transmitted by a transmitting unit or a transmitting module. A signal may be received by a receiving unit or a receiving module. A signal may be processed by a processing unit or a processing module. Other steps may be performed by an AI or machine learning (ML) module. The respective units or modules may be implemented using hardware, one or more components or devices that execute software, or a combination thereof. For instance, one or more of the units or modules may be an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the UEs 114 and TRP 102 are known to those of skill in the art. As such, these details are omitted here.

### A-4. Intelligent Air Interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (for example, data) over a wireless communications link. The wireless communications link may support a link between a RAN and a UE (for example, a “Uu” link), and/or the wireless communications link may support a link between device and device, such as between two user equipments (for example, a “sidelink”), and/or the wireless communications link may support a link between a non-terrestrial (NT)-communication network and a UE. The followings are some examples for the above components:
A waveform component may specify a shape and form of a signal being transmitted. Waveform options may include orthogonal multiple access waveforms and non-orthogonal multiple access waveforms. Non-limiting examples of such waveform options include orthogonal frequency division multiplexing (OFDM), filtered OFDM (f-OFDM), time windowing OFDM, filter bank multicarrier (FBMC), universal filtered multicarrier (UFMC), generalized frequency division multiplexing (GFDM), wavelet packet modulation (WPM), faster than Nyquist (FTN) waveform, Frequency-Modulated Continuous Wave (FMCW), chip waveforms, and low peak-to-average power ratio waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: TDMA, FDMA, CDMA, SC-FDMA, low density signature multicarrier code division multiple access (LDS-MC-CDMA), non-orthogonal multiple access (NOMA), pattern division multiple access (PDMA), lattice partition multiple access (LPMA), resource spread multiple access (RSMA), and sparse code multiple access (SCMA). Furthermore, multiple access technique options may include: scheduled access vs. non-scheduled access, also known as configured grant access or grant-free access; non-orthogonal multiple access vs. orthogonal multiple access, for example, via a dedicated channel resource (for example, no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include Reed-Muller (RM) codes, turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface may not be changed or adapted once the air interface is defined. In some implementations, only limited parameters or modes of an air interface, such as a cyclic prefix (CP) length or a MIMO mode, may be configured. In some embodiments, an air interface design may provide a unified or flexible framework to support below 6 gigahertz (GHz) and beyond 6 GHz frequency (for example, mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible RAN slicing through channel resource sharing between different services in both frequency and time.

### A-5. Frame Structure

A frame structure is a feature of the wireless communication physical layer that defines a time domain signal transmission structure, for example, to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD), time-division duplex (TDD), and/or full duplex (FD; including subband FD) communication may be possible. FDD communication is when transmissions in different directions (for example, UL vs. DL) occur in different frequency bands. TDD communication is when transmissions in different directions (for example, UL vs. DL) occur over different time durations. FD communication is when transmission and reception occurs on the same time-frequency resource, that is, a device may both transmit and receive on the same frequency resource concurrently in time.

One example of a frame structure is a frame structure in long-term evolution (LTE) having the following specifications: each frame is 10 milliseconds (ms) in duration; each frame has 10 subframes, which are each one (1) ms in duration; each subframe includes two slots, each of which is 0.5 ms in duration; each slot is for transmission of seven (7) OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between UL and DL in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of one (1) ms each; a slot is defined as 14 OFDM symbols, and slot length depends upon the numerology. For example, the NR frame structure for normal CP 15 kilohertz (kHz) subcarrier spacing (“numerology 1”) and the NR frame structure for normal CP 30 kHz subcarrier spacing (“numerology 2”) are different. For 15 kHz subcarrier spacing a slot length is one (1) ms, and for 30 kHz subcarrier spacing a slot length is 0.5 ms. The NR frame structure may have more flexibility than the LTE frame structure.

Another example of a frame structure is an example flexible frame structure, for example, for use in a 6G network or later. In a flexible frame structure, a symbol block may be defined as the minimum duration of time that may be scheduled in the flexible frame structure. A symbol block may be a unit of transmission having an optional redundancy portion (for example, CP portion) and an information (for example, data) portion. An OFDM symbol is an example of a symbol block. A symbol block may alternatively be called a symbol. Embodiments of flexible frame structures include different parameters that may be configurable, for example, frame length, subframe length, symbol block length, and/or the like. A non-exhaustive list of possible configurable parameters in some embodiments of a flexible frame structure include:

(1) Frame: The frame length need not be limited to 10 ms, and the frame length may be configurable and change over time. In some embodiments, each frame includes one or multiple DL synchronization channels and/or one or multiple DL broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.

(2) Subframe duration: A subframe might or might not be defined in the flexible frame structure, depending upon the implementation. For example, a frame may be defined to include slots, but no subframes. In frames in which a subframe is defined, for example, for time domain alignment, then the duration of the subframe may be configurable. For example, a subframe may be configured to have a length of 0.1 ms, 0.2 ms, 0.5 ms, one (1) ms, two (2) ms, five (5) ms, or the like. In some embodiments, if a subframe is not needed in a particular scenario, then the subframe length may be defined to be the same as the frame length or not defined.

(3) Slot configuration: A slot might or might not be defined in the flexible frame structure, depending upon the implementation. In frames in which a slot is defined, then the definition of a slot (for example, in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling may be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common, or UE specific.

(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, for example, if more flexible symbol durations are implemented using inverse discrete Fourier transform (IDFT) instead of fast Fourier transform (FIT). Additional examples of frame structures may be used with different SCSs.

(5) Flexible transmission duration of basic transmission unit: The basic transmission unit may be a symbol block (alternatively called a symbol), which in general includes a redundancy portion (referred to as the CP) and an information (for example, data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (for example, data) portion may be flexible and configurable. Another possible parameter relating to a symbol block that may be defined is ratio of CP duration to information (for example, data) duration. In some embodiments, the symbol block length may be adjusted according to: channel condition (for example, multi-path delay, Doppler); and/or latency requirement; and/or available time duration. As another example, a symbol block length may be adjusted to fit an available time duration in the frame.

(6) Flexible switch gap: A frame may include both a DL portion for DL transmissions from a base station, and a UL portion for UL transmissions from UEs. A gap may be present between each UL and DL portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### A-6. Cell, Carrier, Bandwidth Parts, and Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, for example, the center or lowest or highest frequency of the carrier. A carrier may be on licensed or unlicensed spectrum. Wireless communication with the device may also or instead occur over one or more bandwidth parts (BWPs) or certain subband comprising one or more Physical Resource Blocks (PRBs) or other frequency domain basic units. For example, a carrier may have one or more BWPs. More generally, wireless communication with the device may occur over spectrum. The spectrum may comprise one or more carriers and/or one or more BWPs.

A cell may include one or multiple DL resources and optionally one or multiple UL resources, or a cell may include one or multiple UL resources and optionally one or multiple DL resources, or a cell may include both one or multiple DL resources and one or multiple UL resources. As an example, a cell might only include one DL carrier/BWP, or only include one UL carrier/BWP, or include multiple DL carriers/BWPs, or include multiple UL carriers/BWPs, or include one DL carrier/BWP and one UL carrier/BWP, or include one DL carrier/BWP and multiple UL carriers/BWPs, or include multiple DL carriers/BWPs and one UL carrier/BWP, or include multiple DL carriers/BWPs and multiple UL carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, for example, a carrier may have a bandwidth of 20 megahertz (MHz) and consist of one BWP, a bandwidth of 80 MHz and consist of two adjacent contiguous BWPs, and/or the like. In other embodiments, a BWP may have one or more carriers, for example, a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmWave band, the second carrier may be in a low band (such as 2 GHz band), the third carrier (if it exists) may be in terahertz (THz) band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0-5%.

The carrier, the BWP, or the occupied bandwidth may be signaled by a network device (for example, base station) dynamically, for example, in physical layer control signaling such as downlink control information (DCI), or semi-statically, for example, in RRC signaling or in the MAC layer, or be predefined based on the application scenario; or be determined by the UE as a function of other parameters that are known by the UE, or may be fixed, for example, by a standard.

### A-7. Timing Reference Point

In current networks, frame timing and synchronization is established based on synchronization signals, such as a primary synchronization signal (PSS) and a secondary synchronization signal (SSS). Notably, known frame timing and synchronization strategies involve adding a timestamp, for example, (xx0:yy0:zz), to a frame boundary, where xx0, yy0, zz in the timestamp may represent a time format such as hour, minute, and second, respectively.

It is anticipated that diverse applications and use cases in future networks may involve usage of different periods of frames, slots and symbols to satisfy the different requirements, functionalities and quality of service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

In some embodiments, frame timing alignment and/or realignment may comprise a timing alignment and/or realignment in terms of a boundary of a symbol, a slot or a sub-frame within a frame; or a frame (thus the frame timing alignment/realignment here is more general, not limiting to the cases where a timing alignment/realignment is from a frame boundary only). Also, relative timing to a frame or frame boundary may be interpreted in a more general sense, that is, the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In some embodiments, a network device such as a base station 102, referenced hereinafter as a TRP 102, may transmit signaling that carries a timing realignment indication message. The timing realignment indication message includes information allowing a receiving UE 114 to determine a timing reference point. On the basis of the timing reference point, transmission of frames, by the UE 114, may be aligned. In some embodiments, the frames that become aligned are in different sub-bands of one carrier frequency band. In some other embodiments, the frames that become aligned are found in neighboring carrier frequency bands.

On the TRP 102 side, one or more types of signaling may be used to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 114 of a configuration of a timing reference point. References, hereinafter, to the term “UE” may be understood to represent reference to a broad class of generic wireless communication devices within a cell (that is, a network receiving node, such as a wireless device, a sensor, a gateway, a router, or the like), that is, being served by the TRP 102. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, for example, the start of the current frame. Alternatively, the timing reference point may be expressed in terms of an absolute timing based on certain standards timing reference such as a global navigation satellite system (GNSS) (for example, global positioning system (GPS)), coordinated universal time (“UTC”), and/or the like. In the absolute timing version of the timing reference point, a timing reference point may be explicitly stated.

The timing reference point may be shown to allow for timing adjustments to be implemented at the UEs 114. The timing adjustments may be implemented for improvement of accuracy for a clock at the UE 114. Alternatively, or additionally, the timing reference point may be shown to allow for adjustments to be implemented in future transmissions made from the UEs 114. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs 114 and one or more BSs 102 (in a cell or a group of cells).

At UE 114 side, the UE 114 may monitor for the timing realignment indication message. Responsive to receiving the timing realignment indication message, the UE 114 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 114 may cause the TRP 102 to transmit the timing realignment indication message by transmitting, to the TRP 102, a request for a timing realignment, that is, a timing realignment request message. Responsive to receiving the timing realignment request message, the TRP 102 may transmit, to the UE 114, a timing realignment indication message including information on a timing reference point, thereby allowing the UE 114 to implement a timing realignment (or/and a timing adjustment including clock timing error correction), wherein the timing realignment is in terms of (for example, a starting boundary of) a symbol, a slot or a sub-frame within a frame; or a frame for UEs and base station(s) in a cell (or a group of cells).

In some embodiments, a TRP 102 associated with a given cell may transmit a timing realignment indication message. The timing realignment indication message may include enough information to allow a receiver of the message to obtain a timing reference point. The timing reference point may be used, by one or more UEs 114 in the given cell, when performing a timing realignment (or/and a timing adjustment including clock timing error correction).

In some embodiments, the timing reference point may be expressed, within the timing realignment indication message, relative to a frame boundary (where a frame boundary may be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, that is, Δt, subsequent to a frame boundary for a given frame. Since the frame boundary is important to allowing the UE 114 to determine the timing reference point, it is important that the UE 114 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a master information block (MIB) and the remaining four bits of the 10 bits for the SFN may be carried in a physical broadcast channel (PBCH) payload.

Optionally, the timing realignment indication message may include other parameters. The other parameters may, for example, include a minimum time offset. The minimum time offset may establish a duration of time preceding the timing reference point. The UE 114 may rely upon the minimum time offset as an indication that DL signaling, including the timing realignment indication message, will allow the UE 114 enough time to detect the timing realignment indication message to obtain information on the timing reference point.

### A-8. Precoding

Precoding as used herein may refer to any coding operation(s) or modulation(s) that transform an input signal into an output signal. Precoding may be performed in different domains, and typically transform the input signal in a first domain to an output signal in a second domain. Precoding may include linear operations.

### A-9. Multiple-Input Multiple-Output (MIMO)

MIMO technology allows an antenna array of multiple antennas to perform signal transmissions and receptions to meet high transmission rate requirement. The UEs 114 and/or TRPs 102 may use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above TRP 102 configured with a large number of antennas has gained wide attentions from the academia and the industry. In the large-scale MIMO system, the TRP 102 may be generally configured with more than ten antenna units (such as antennas 148 shown in FIG. 2A), and serves for dozens of the UE 114 in the meanwhile. A large number of antenna units of the TRP 102 may greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the TRP 102 of each cell may communicate with many UEs 114 in the cell on the same time-frequency resource at the same time, thus greatly increasing the spectrum efficiency. A large number of antenna units of the TRP 102 also enable each user to have improved spatial directivity for UL and DL transmission, so that the transmitting power of the TRP 102 and/or a UE 114 is obviously reduced, and the power efficiency is greatly increased. When the antenna number of the TRP 102 is sufficiently large, random channels between each UE 114 and the TRP 102 may approach to be orthogonal, and the interference between the cell and the users and the effect of noises may be eliminated. The plurality of advantages described above enable the large-scale MIMO to have a magnificent application prospect.

A MIMO system may include a receiver connected to a receiving (Rx) antenna, a transmitter connected to transmitting (Tx) antenna, and a signal processor connected to the transmitter and the receiver. Each of the Rx antenna and the Tx antenna may include a plurality of antennas. For instance, the Rx antenna may have a uniform linear array (ULA) antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:

Panel: unit of antenna group, or antenna array, or antenna sub-array which may control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, antenna port(s) identifier, channel state information reference signal (CSI-RS) resource identifier, SSB resource identifier, sounding reference signal (SRS) resource identifier, codebook indication, beam direction indication, or other reference signal resource identifier.

### A-10. Integrated Terrestrial Network (TN) and Non-Terrestrial Network (NTN)

A terrestrial communication system may also be referred to as a land-based or ground-based communication system, although a terrestrial communication system may also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communications using 5G technology and/or later generation wireless technology (for example, 6G or later). In some examples, the terrestrial communication system may also accommodate some legacy wireless technology (for example, 3G or 4G wireless technology). The non-terrestrial communication system may be a communications using the satellite constellations like conventional geostationary orbit (GEO) satellites which utilizing broadcast public/popular contents to a local server, low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or unmanned aerial vehicles (UAVs) (or unmanned aerial system (UAS)) achieving a dense deployment since their coverage may be limited to a local area, such as airborne, balloon, quadcopter, drones, and/or the like. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

### A-11. Artificial Intelligence or Machine Learning (AI/ML)

AI technologies may be applied in communication, including AI/ML based communication in the physical layer and/or AI/ML based communication in the higher layer, for example, MAC layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, for example to optimize the functionality in the MAC layer, for example intelligent TRP management, intelligent beam management, intelligent channel resource allocation, intelligent power control, intelligent spectrum utilization, intelligent modulation and coding scheme (MCS), intelligent HARQ strategy, intelligent transmit/receive (Tx/Rx) mode adaption, and/or the like.

The following are some terminologies which are used in AI/ML field:

### Data Collection:

Data is the very important component for AI/ML techniques. Data collection is a process of collecting data by the network nodes, management entity, or UE for the purpose of AI/ML model training, data analytics and inference.

### AI/ML Model Training:

AI/ML model training is a process to train an AI/ML Model by learning the input/output relationship in a data driven manner and obtain the trained AI/ML Model for inference.

### AI/ML Model Inference:

A process of using a trained AI/ML model to produce a set of outputs based on a set of inputs.

### AI/ML Model Validation:

As a sub-process of training, validation is used to evaluate the quality of an AI/ML model using a dataset different from the one used for model training. Validation may help selecting model parameters that generalize beyond the dataset used for model training. The model parameter after training may be adjusted further by the validation process.

### AI/ML Model Testing:

Similar with validation, testing is also a sub-process of training, and it is used to evaluate the performance of a final AI/ML model using a dataset different from the one used for model training and validation. Differently from AI/ML model validation, testing do not assume subsequent tuning of the model.

### Online Training:

Online training means an AI/ML training process where the model being used for inference is typically continuously trained in (near) real-time with the arrival of new training samples.

### Offline Training:

An AI/ML training process where the model is trained based on collected dataset, and where the trained model is later used or delivered for inference.

### AI/ML Model Delivery/Transfer:

A generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### Life Cycle Management (LCM):

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in NR air-interface.

Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring may be based on inference accuracy, including metrics related to intermediate key performance indicators (KPIs), and it may also be based on system performance, including metrics related to system performance KPIs, for example, accuracy and relevance, overhead, complexity (computation and memory cost), latency (timeliness of monitoring result, from model failure to action) and power consumption. Moreover, data distribution may shift after deployment due to the environment changes, thus the model based on input or output data distribution may also be considered.

### Supervised Learning:

The goal of supervised learning algorithms is to train a model that maps feature vectors (inputs) to labels (output), based on the training data which includes the example feature-label pairs. The supervised learning may analyze the training data and produce an inferred function, which may be used for mapping the inference data.

Supervised learning may be further divided into two types: Classification and Regression. Classification is used when the output of the AI/ML model is categorical, that is, with two or more classes. Regression is used when the output of the AI/ML model is a real or continuous value.

### Unsupervised Learning:

In contrast to supervised learning where the AI/ML models learn to map the input to the target output, the unsupervised methods learn concise representations of the input data without the labelled data, which may be used for data exploration or to analyze or generate new data. One typical unsupervised learning is clustering which explores the hidden structure of input data and provide the classification results for the data.

### Reinforce Learning:

Reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent may take the next action based on the received reward and new state in the environment. During the training phase, the agent interacts with the environment to collect experience. The environments often mimicked by the simulator since it is expensive to directly interact with the real system. In the inference phase, the agent may use the optimal decision-making rule learned from the training phase to achieve the maximal accumulated reward.

### Federated Learning:

Federated learning (FL) is a machine learning technique that is used to train an AI/ML model by a central node (for example, server) and a plurality of decentralized edge nodes (for example, UEs, next Generation NodeBs, “gNBs”).

According to the wireless FL technique, a server may provide, to an edge node, a set of model parameters (for example, weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure are performed multiple iterations until the global AI/ML model is considered to be finalized, for example, the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, and/or the like. For the MAC layer, the AI communication may aim to utilize the AI capability for learning, prediction, and/or making a decision to solve a complicated optimization problem with possible better strategy and/or optimal solution, for example, to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, intelligent transmission/reception mode adaption, and/or the like.

An AI architecture may involve multiple nodes, where the multiple nodes may possibly be organized in one of two modes, that is, centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, for example, distributed machine learning and federated learning. In some embodiments, an AI architecture may comprise an intelligent controller which may perform as a single agent or a multi-agent, based on joint optimization or individual optimization. New protocols and signaling mechanisms are desired so that the corresponding interface link may be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, for example, to optimize one or more components of the air interface, will be referred to herein as an “AI enabled air interface”. In some embodiments, there may be two types of AI operation in an AI enabled air interface: both the network and the UE implement learning; or learning is only applied by the network.

### B. Sensing in Communication System

As described above, the communication system 100 or communication devices thereof often need to or prefer to understand the environment, which may be achieved via sensing.

Sensing is a technology of obtaining surrounding information, such as the information of an object including, for example, the object's location, speed, distance, orientation, shape, texture, and/or the like. Generally, sensing may be broadly classified as:
RF sensing: Sending a RF signal and obtaining the surrounding information by receiving and processing of this RF signal or the echoed or otherwise reflected RF signal; and
Non-RF sensing: Obtaining surrounding information via means using non-RF signals such as video camera or other sensors.

RF sensing may be further classified as:
Active sensing (also denoted “device-based sensing”): A sensing device sends a RF signal to a target device. The target device detects the RF signal, obtains sensed information from the RF signal or by measuring some intermediate information thereof, and then feeds the sensed information back to the sensing device.
Passive sensing (also denoted “device-free sensing”): A sensing device sends a RF signal to an object, detects the echo of the RF signal (that is, the reflected RF signal), and obtains the sensed info from the echo.

An example of passive sensing is the radar system, wherein a sensing device may send a RF signal to localize, detect, and track a target object. A radar system is typically implemented as a standalone system for a specific application.

In passive sensing, the object such as ambient IoT devices (which are smaller and cheaper IoT devices compared to traditional IoT devices) may or may not contain certain identifier (ID) information (such as RF tags).

Generally, from the transmitter and receiver point of view, there are three types of sensing:
Monostatic sensing, wherein the transmitter and receiver are the same device;
Bi-static sensing, wherein the transmitter and receiver are different devices; for example, a TRP 102 may act as the transmitter and send the RF signals for sensing, and a UE 114 may act as the receiver and receive the RF signals;
Multi-static sensing, which may be decomposed into a plurality of bi-static Tx-Rx pairs; for example, a TRP 102 may send the RF signals for sensing, and two UEs 114 (such as UE1, UE2) may receive the RF signals, thereby forming a first Tx-Rx pair between the TRP 102 and UE1, and a second Tx-Rx pair between the TRP 102 and UE2.

### C. Integrated Sensing and Communication

### C-1. Radio Detection and Ranging (Radar)

The term RADAR originates from the phrase radio detection and ranging; however, expressions with different forms of capitalization (that is, Radar and radar) are equally valid and now more common. Radar is typically used for detecting a presence and a location of an object. A radar system radiates radio frequency energy and receives echoes of the energy reflected from one or more targets. The system determines a given target based on the echoes returned from the given target. The radiated energy may be in the form of an energy pulse or a continuous wave, which may be expressed or defined by a particular waveform. Examples of waveforms used in radar include frequency modulated continuous wave (FMCW) and ultra-wideband (UWB) waveforms.

Radar systems may be monostatic, bi-static, or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

### C-2. Introduction

UE position information is often used in cellular communication networks to improve various performance metrics for the network. Such performance metrics may, for example, include capacity, agility, and efficiency. The improvement may be achieved when elements of the network exploit the position, the behavior, the mobility pattern, and/or the like, of the UE 114 in the context of a priori information describing a wireless environment in which the UE is operating.

A sensing system may be used to help gather UE information, including its location in a reference system such as a global coordinate system, a local coordinate system, a reference system with respect to certain reference point(s), or the like, its velocity and direction of movement in the reference system, orientation information, and the information about the wireless environment. Herein, the term “location” is also known as “position” and these two terms may be used interchangeably herein. Examples of well-known sensing systems include radio detection and ranging (RADAR) and light detection and ranging (LIDAR). While the sensing system may be separate from the communication system, it may be advantageous to gather the information using an integrated system, which may reduce the hardware (and cost) in the system as well as the time, frequency, or spatial resources needed to perform both functionalities. However, using the communication system hardware to perform sensing of an object (such as sensing the object and its position or localization, shape, orientation, gesture, and/or the like) and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

### C-3. Sensing Node, Sensing Management Function

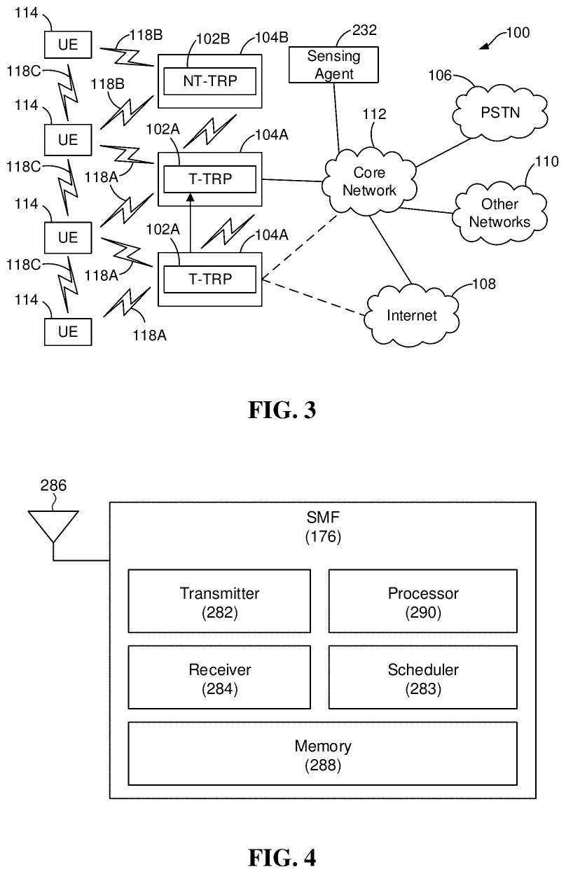

As shown in FIG. 3, any or all of the UEs 114 and TRPs 102 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 232 is an example of a sensing node that is dedicated to sensing. Unlike the UEs 114 and TRPs 102, the sensing agent 232 does not transmit or receive communication signals. However, the sensing agent 232 may communicate configuration information, sensing information, signaling information, or other information within the communication system 100. The sensing agent 232 may be in communication with the core network 112 to communicate information with the rest of the communication system 100. By way of example, the sensing agent 232 may determine the location of the UE 114, and transmit this information to the TRP 102 via the core network 112. Although only one sensing agent 232 is shown in FIG. 3, any number of sensing agents may be implemented in the communication system 100. In some embodiments, one or more sensing agents may be implemented at one or more of the RANs 104.

A sensing node may combine sensing-based techniques with reference signal-based techniques to enhance the determination of UE-related information. This type of sensing node may also be known as a sensing management function (SMF). In some networks, the SMF may also be known as a location management function (LMF). In some embodiments, the SMF may be implemented as a physically independent entity located at the core network 112 with connection to the multiple TRPs 102. In some other embodiments, the SMF may be implemented as a logical entity co-located inside a TRP 102 through logic carried out by the processor 142.

As shown in FIG. 4, the SMF 176, when implemented as a physically independent entity, includes at least one processor 290, at least one transmitter 282, at least one receiver 284, one or more antennas 286, and at least one memory 288. A transceiver, not shown, may be used instead of the transmitter 282 and receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing, or any other functionality. The processor 290 may also be configured to implement some or all of the functionality and/or embodiments described in more detail above. Each processor 290 includes any suitable processing or computing device configured to perform one or more operations. Each processor 290 may, for example, include a microprocessor, a microcontroller, a digital signal processor, a FPGA, or an ASIC.

A reference signal-based object determination technique may involve an “active” pose estimation paradigm. In an active pose estimation paradigm, the enquirer of pose information (that is, the UE 114) takes part in process of determining the pose of the enquirer. The enquirer may transmit or receive (or both) a signal specific to pose determination process. Positioning techniques based on a GNSS such as a GPS are other examples of the active pose estimation paradigm.

In contrast, a sensing technique, based on radar for example, may be considered as involving a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques may yield enhanced object determination.

The enhanced object determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information may also facilitate sub-space based sensing to reduce sensing complexity and improve sensing accuracy.

### C-4. Sensing Channel

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal, and a second set of channels may be used to transmit a communications signal. In some embodiments, each channel in the first set of channels and each channel in the second set of channels is a logical channel, a transport channel, or a physical channel.

At the physical layer, communication and sensing may be performed via separate physical channels. For example, a first physical downlink shared channel PDSCH-C is defined for data communication, while a second physical downlink shared channel PDSCH-S is defined for sensing, such as sensing data sharing for cooperative sensing, sensing reference signals, and/or the like. Similarly, separate physical uplink shared channels (PUSCHs), PUSCH-C and PUSCH-S, may be defined for UL communication and sensing. For example, PUSCH-S may be used for sensing result report and sensing data sharing.

In another example, the same PDSCH and PUSCH may be also used for both communication and sensing, with separate logical layer channels and/or transport layer channels defined for communication and sensing. Note also that control channel(s) and data channel(s) for sensing may have the same or different channel structure (format), occupy same or different frequency bands or bandwidth parts.

In a further example, a common physical downlink control channel (PDCCH) and a common physical uplink control channel (PUCCH) is used to carry control information for both sensing and communication. Alternatively, separate physical layer control channels may be used to carry separate control information for communication and sensing. For example, PUCCH-S and PUCCH-C may be used for UL control for sensing and communication respectively, and PDCCH-S and PDCCH-C for DL control for sensing and communication respectively.

Different combinations of shared and dedicated channels for sensing and communication, at each of the physical, transport, and logical layers, are possible.

### C-5. Half-Duplex and Full-Duplex

Communication nodes may be either half-duplex or full-duplex. A half-duplex node may not both transmit and receive using the same physical resources (time, frequency, and/or the like); conversely, a full-duplex node may transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (for example, in the millimeter wave bands), and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes may perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

### C-6. Sensing Signal Waveform and Frame Structure

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that may be used for a sensing signal include UWB pulse, FMCW or “chirp”, OFDM, CP-OFDM, and discrete Fourier transform spread (DFT-s)-OFDM.

### C-7. Integrated Sensing and Communication (ISAC) System and Sensing and Communication (SAC) Signal

In some embodiments, the communication system 100 is an integrated sensing and communication (ISAC) system to use the RF signals transmitted between various devices (such as between TRPs 102 and UEs 114, between different TRPs 102, between different UEs 114, and the like) for both sensing and communication. Thus, the communication system 100 is a networked and cooperative sensing system rather than a standalone radar system. Cooperating sensing may be achieved via the integrated communication protocols.

As those skilled in the art understand, a first communication node (such as a TRP 102) may transmit a RF signal to one or more second communication nodes (such as UEs 114) and use the RF signal for different purposes such as for signaling or data transmission. In these embodiments, the RF signal or a portion thereof may also be used for sensing. In the following description, the RF signal that is used for both sensing and communication may be denoted the “sensing and communication (SAC) signal”, and the communication nodes (such as TRPs 102, UEs 114, sensing devices, relays, or the like) that use the SAC signal are also denoted “SAC nodes”. Herein, a SAC signal is or comprises a physical signal or channel (denoted “signal/channel”; such as a reference signal) for communication. Alternatively, a SAC signal is or comprises a physical signal/channel for sensing (where the signal/channel uses OFDM waveform or other waveform (such as chirp)). Still alternatively, a SAC signal is or comprises a signal/channel for both communication and sensing.

Depending on the role thereof, a SAC node may be a transmitter node (also denoted “Tx node”) if the SAC node transmits the SAC signal, or a receiver node (also denoted “Rx node”) if the node receives a SAC signal and/or the echo thereof (that is, the reflected SAC signal). Moreover, a communication node may act as a Tx node (when it is transmitting a SAC signal) or a Rx node (when it is receiving a SAC signal and/or the echo thereof), or both (when it is transmitting a SAC signal and receiving another SAC signal and/or echo thereof at the same time).

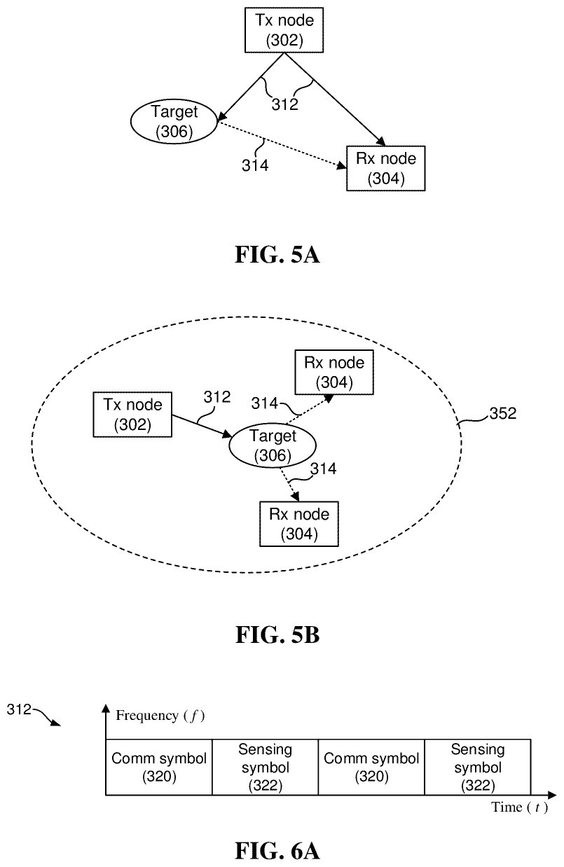

In some embodiments, the communication system 100 may use a cooperative sensing method for detecting objects (also denoted a “target”). FIG. 5A is a schematic diagram showing an example of the cooperative sensing method. As shown, a Tx node 302 transmits a SAC signal 312. A Rx node 304 receives the SAC signal 312 and an echo 314 thereof reflected from a target object 306 (or simply denoted an “object”). The Rx node 304 may detect and measure the received SAC signal 312 and/or the echo 314, and report the measured parameters thereof to the Tx node 302. Alternatively, the Rx node 304 may detect and measure the received SAC signal 312 and/or the echo 314, and may further measure the parameters of the object 306 (such as azimuth, size, velocity, and/or the like) based on the received SAC signal 312 and/or the echo 314 thereof, and then reports the detected object 306 and the parameters thereof to the Tx node 302. The object 306 may be positioned near or at a certain distance from the Rx node 304, as long as the Rx node 304 is able to detect and measure the parameters of the object 306. In the following, the term “measurement results” is used which generally refers to the measured parameters of the received SAC signal 312, one or more measured parameters of the echo 314, and/or one or more measured parameters of the object 306.

FIG. 5B is a schematic diagram showing another example where a Tx node 302 is cooperating with two Rx nodes 304 to sense the object 306. More specifically, the Rx nodes 304 receive the echoes 314 of the SAC signal 312 and report the measurement results to the Tx node 302 such that the Tx node 302 may determine the location of the object 306 by using, for example, triangulation.

Similarly, a Rx node 304 may cooperate with two Tx nodes 302 for object sensing.

In various embodiments, the measurement results may comprise one or more channel-related measurements (that is, measurement results of the received SAC signal 312 and/or the echo 314) and/or one or more object-related measurements (that is, measurement results of the object 306). The following lists some examples of the channel-related measurements:
delay of the first path between the Tx node 302 and the Rx node 304;
delay of the path between the Tx node 302 and the Rx node 304 that has the maximum power among all paths therebetween; and/or
power of received reflected signal (for example, the reference signal received power (RSRP) thereof).

The following lists some examples of the object-related measurements:
distance between the Rx node 304 and the object 306;
azimuth or angle of the object 306;
elevation of the object 306;
the range (that is, the upper-bound and/or lower-bound) of the distance value of the object 306;
the range (that is, the upper-bound and/or lower-bound) of the azimuth value of the object 306;
the range (that is, the upper-bound and/or lower-bound) of the elevation value of the object 306;
the linear span (such as the length or width) of the object 306;
the azimuth or angular span (such as the angular size) of the object 306;
the elevation span (such as the height) of the object 306;
the radial velocity of the object 306;
the azimuth or angular velocity of the object 306;
the elevation velocity of the object 306; and/or
the number of object 306 (such as no detected object (that is, zero (0) object), one (1) detected object, two (2) detected objects, or the like).

The first path typically represents the shortest path between the Tx node 302 and the Rx node 304, or the path through which the data transmission or SAC signal takes the shortest time to travel. The azimuth or angle of the object 306 typically represents the orientation of the object 306 relative to the Rx node 304, the orientation of the Rx node 304 relative to the object 306, or an absolute value of the orientation relative to the earth or another stationary object. The elevation of the object 306 typically represents the height of the object 306 relative to the Rx node 304, or an absolute value of height such as altitude. The other parameters may be relative values with respect to the Rx node 304 or another object, or may be absolute values.

In some embodiments, the SAC signal 312 may comprise one or more communication symbols for communication and one or more sensing symbols for sensing. In various embodiments, the communication symbols and sensing symbols may be OFDM symbols (in the SAC signal 312 using OFDM) or non-OFDM symbols (in the SAC signal 312 not using OFDM). Herein, a symbol is generally a signal component or a transmission opportunity that forms a part of the SAC signal 312. For example, in a SAC signal 312 not using OFDM (that is, a non-OFDM based SCA signal), a symbol may be a signal component carrying information (that is, a communication symbol) or a signal component for sensing (that is, a sensing symbol such as a chirp signal).

In the transmission and receiving of the SAC signal 312, the sensing and communication symbols are aligned in time and/or frequency such that a sensing symbol may be transmitted and received as if it is a communication symbol. Consequently, the Tx node 302 and Rx node 304 may use existing transmitting and receiving technologies to transmit and receive the sensing symbols, and/or follow the transmitting and receiving specifications of existing wireless communication standards to transmit and receive the sensing symbols. The benefit is high efficiency of resource utilization for sensing and communication. For example, when the resource is not used by communication, it can be used for sensing without resulting fragment resource.

Herein, the concept of “signal alignment in time” means that, when a plurality of symbols (which may be sensing symbols and/or communication symbols) are transmitted in the SAC signal 312, each symbol has a time duration Tₛ≤T, and each symbol is transmitted between tₛ+nT and tₛ+(n+1)T, where Tis a predefined or configured time duration, tₛ is a time offset, and n≥0 is an integer.

Similarly, the concept of “signal alignment in frequency” means that, when a plurality of symbols (which may be sensing symbols and/or communication symbols) are transmitted, each symbol has a frequency bandwidth BWₛ≤BW, and each symbol is transmitted within a frequency band from fₛ+mBW to fₛ+(m+1)BW, where BW is a predefined or configured bandwidth (which may be one or more physical resource blocks (PRBs)), fₛ is a frequency offset, and m≥0 is an integer. In some embodiments, the bandwidth configuration may be based on BWPs. For example, in some embodiments, a TRP 102 may allocate one BWP for communication and another BWP for sensing. In some embodiments, communication and sensing may use the same BWP. Alternatively, the BWP for communication may be within the BWP for sensing, or the BWP for sensing may be within the BWP for communication. In various embodiments, for switching between communication and sensing, a UE 114 may switch to the corresponding BWP, with a BWP switching delay being zero.

Accordingly, the concept of “signal alignment in time and frequency” means that, when a plurality of symbols (which may be sensing symbols and/or communication symbols) are transmitted in the SAC signal 312,
each symbol has a time duration Tₛ≤T, and each symbol is transmitted between tₛ+nT and tₛ+(n+1)T; and
each symbol has a frequency bandwidth BWₛ≤BW, and each symbol is transmitted within a frequency band from fₛ+mBW to fₛ+(m+1)BW.

For example, in some embodiments, the sensing symbol may have the same time duration Tₛ=T (which may include unused time period) and same bandwidth BWₛ=BW (which may include unused frequency range) as those of the communication symbol.

In the SAC signal 312, the sensing and communication symbols may be multiplexed using any suitable multiplexing methods.

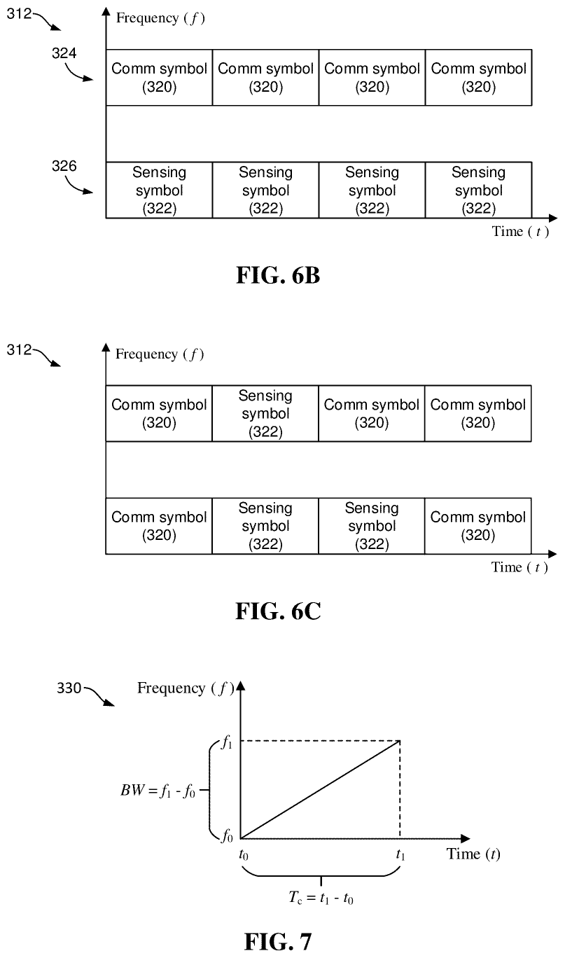

For example, FIG. 6A is a frequency-time diagram showing an example of the SAC signal 312, wherein a plurality of communication symbols 320 and a plurality of sensing symbols 322 are multiplexed in time using a suitable time-division multiplexing (TDM) method.

As another example, FIG. 6B shows a SAC signal 312, wherein a plurality of communication symbols 320 and a plurality of sensing symbols 322 are multiplexed in frequency using a suitable frequency-division multiplexing (FDM) method, such that the plurality of communication symbols 320 are transmitted in a first frequency band 324 and the plurality of sensing symbols 322 are transmitted in a second frequency band 326.

As yet another example, FIG. 6C shows a SAC signal 312, wherein a plurality of communication symbols 320 and a plurality of sensing symbols 322 are multiplexed in both frequency and time using a suitable TDM/FDM method, such that each of the first and second frequency bands 324 and 326 transmits a mixture of communication symbols 320 and sensing symbols 322 multiplexed in time.

As still another example, a SAC signal 312 may comprise a plurality of communication symbols 320 and a plurality of sensing symbols 322 multiplexed in frequency, time, space, code, and/or the like using suitable TDM, FDM, special division multiplexing (SDM), code division multiplexing (CDM) methods or the like.

In various embodiments, the parameters of the sensing symbols 322 of the SAC signal 312 may be predefined (such as according to one or more communication standards) and/or configured by the Tx node 302 such as a TRP 102 to ensure the alignment of the sensing symbols 322 and the communication symbols 320. In other words, in various embodiments, all, some, or none of parameters of the sensing symbols 322 may be determined by the Tx node 302, and accordingly, none, some, or all of parameters of the sensing symbols 322 may be predefined.

When configuring the sensing symbols 322, the Tx node 302 may individually determine a set of parameters for each of one or more sensing symbols 322 such that each of the one or more sensing symbols 322 may use a different set of parameters. The Tx node 302 may also or alternatively determine a set of parameters for one or more other sensing symbols 322 such that the one or more other sensing symbols 322 may use the same set of parameters. Similarly, each of one or more sensing symbols 322 may use a specific set of predefined parameters, and/or one or more other sensing symbols 322 may use a same set of predefined parameters.

The Tx node 302 or TRP 102 may notify the Rx node 304 the parameters of the sensing symbols 322 (if any) that it configured. The Tx node 302 may not need to notify the Rx node 304 regarding the predefined parameters of the sensing symbols 322 as such parameters may have been known by the Rx node 304 (for example, according to the specification of the one or more communication standards).

Below are examples of the parameters of the sensing symbols 322 that may be predefined and/or configured by the Tx node 302:
the frequency bands of the sensing symbols 322; and/or
the index of each sensing symbol 322 or the index of each sensing burst having a plurality of sensing symbols 322.

In some embodiments, a sensing symbol 322 may comprise one or more sensing signals such as one or more chirp signals for transmission within the time duration Tₛ and bandwidth BWₛ. As those skilled in the art understand, a chirp signal is a signal in which the frequency increases (up-chirp) or decreases (down-chirp) with time. One type of the chirp signal is the linear chirp signal, wherein the frequency thereof varies linearly with time. As shown in FIG. 7, a linear chirp signal 330 may be expressed in the frequency domain as:

$$f ( t ) = {f}_{0} + {u}_{0} ( t - {t}_{0} ) \qquad ( 1 )$$

for t₀≤t≤t₁, where t₀ is the starting time instant (that is, the staring time position) of the linear chirp signal 330, t₁ is the ending time instant (that is, the ending time position) of the linear chirp signal 330, T_{c}=t₁−t₀ is the duration of the linear chirp signal 330 and T_{c}≤Tₛ, f₀ is the starting frequency at time instant t=t₀, f₁ is the ending frequency at time instant t=t₁, and u₀ is a constant called the chirp rate (also called the slope of chirp signal). The bandwidth BW_{c} of the linear chirp signal 330 is BW_{c}=f₁−f₀=u₀T_{c} and BW_{c}≤BWₛ. In other words, the chirp duration T_{c}=BW_{c}/u₀.

The time-domain expression of the linear chirp signal 316 is:

$$x ( t ) = exp ( j 2 π ( {f}_{0} ( t - {t}_{0} ) + \frac{1}{2} {{u}_{0} ( t - {t}_{0} )}^{2} ) ) \qquad ( 2 )$$

for t₀≤t≤t₁.

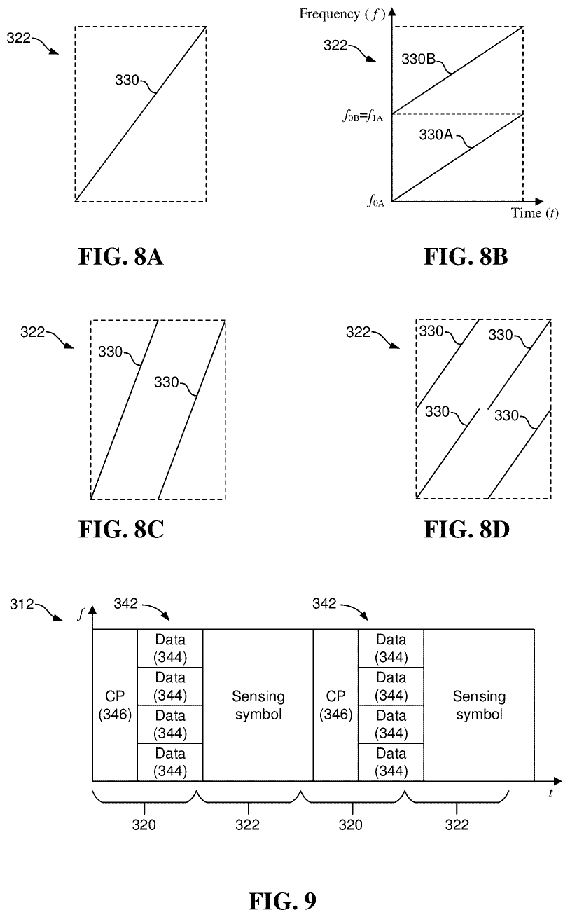

As shown in FIG. 8A, in some embodiments, a sensing symbol 322 may comprise one chirp signal 330. In this example, the duration T_{c} of the chirp signal 330 is smaller than or equal to the sensing-symbol time duration Tₛ, that is, T_{c}≤Tₛ (when T_{c}<Tₛ, some of the sensing-symbol duration Tₛ is unused). The slope u₀ is u₀=BW_{c}/T_{c}. The Tx node 302 or TRP 102 may configure the bandwidth BW_{c} of the chirp signal 330, and notify the Rx node 304 regarding the configuration. Alternatively, the Tx node 302 may configure the slope u₀ of the chirp signal 330 under the condition that BW_{c}≤BWₛ (when BW_{c}<BWₛ, some of the sensing-symbol bandwidth BWₛ is unused), and notify the Rx node 304 regarding the configuration.

In some embodiments, a sensing symbol 322 may comprise a plurality of chirp signals 330, wherein the plurality of chirp signals 330 are multiplexed in frequency using FDM and/or in time using TDM.

In some embodiments, a sensing symbol 322 may comprise a plurality of chirp signals 330 aligned in time and/or frequency, wherein the plurality of chirp signals 330 are multiplexed in frequency using FDM and/or in time using TDM. Herein, the concept of alignment of the plurality of chirp signals 330 of the sensing symbol 322 in time and/or frequency is similar to that described above except that the plurality of chirp signals 330 are within the time duration and frequency band of the sensing symbol 322.

For example, FIG. 8B shows a sensing symbol 322 having two chirp signals 330 multiplexed in frequency. The Tx node 302 may configure the bandwidth BW_{c}, the starting frequency f₀, the ending frequency f₁, and/or the slope u₀ of each chirp signal 330, and notify the Rx node 304 regarding the configuration as needed. In this example, each chirp signal 330 has a time duration T_{c}≤Tₛ. The sum of the bandwidths of the two chirp signals 330 needs to satisfy the condition:

$${\sum }_{all chirp signals} {BW}_{c} \leq {BW}_{s} \qquad ( 3 )$$

As another example, FIG. 8C shows a sensing symbol 322 having M chirp signals 330 multiplexed in time, where M>1 is an integer (for example, M=2 in FIG. 8C). The Tx node 302 may configure the bandwidth BW_{c}, the starting frequency f₀, the ending frequency f₁, the slope u₀, starting time instant t₀, and/or ending time instant t₁ of each chirp signal 330, and notify the Rx node 304 regarding the configuration as needed. In this example, each chirp signal 330 has a bandwidth BW_{c}≤BWₛ. The sum of the time durations of the two chirp signals 330 needs to satisfy the condition:

$${\sum }_{all chirp signals} {T}_{c} \leq {T}_{s} \qquad ( 4 )$$

As yet another example, FIG. 8D shows a sensing symbol 322 having four chirp signals 330 multiplexed in frequency and time. The Tx node 302 may configure the bandwidth BW_{c}, the starting frequency f₀, the ending frequency f₁, the slope u₀, starting time instant t₀, and/or ending time instant t₁ of each chirp signal 330, and notify the Rx node 304 regarding the configuration as needed. In this example, each chirp signal 330 has a bandwidth BW_{c}≤BWₛ. The total time durations of the chirp signals 330 (some of the chirp signals 330 may overlap in time) needs to be smaller than or equal to Tₛ, and the total bandwidth of the chirp signals 330 (some of the chirp signals 330 may overlap in frequency) needs to be smaller than or equal to BWₛ.

In various embodiments, a Tx node 302 or a TRP 102 may configure the number of the chirp signals 330 in a sensing symbol 322 and/or use a predefined the number of the chirp signals 330 in a sensing symbol 322 for sensing.

In various embodiments, a Tx node 302 or a TRP 102 may configure the parameters of the chirp signals 330 and/or use predefined parameters thereof to ensure the alignment of the sensing symbols 322 and the communication symbols 320.

When configuring the chirp signals 330, the Tx node 302 may individually determine a set of parameters for each of one or more chirp signals 330 such that the one or more chirp signals 330 may use different parameters, or may also or alternatively determine a set of parameters for one or more other chirp signals 330 such that the one or more chirp signals 330 may use the same set of parameters. Similarly, each of one or more chirp signals 330 may use a specific set of predefined parameters, and/or one or more other sensing symbols 322 may use a same set of predefined parameters.

The Tx node 302 may notify the Rx node 304 the number of chirp signals 330 and/or the parameters of the chirp signals 330 (if any) that it configured. The Tx node 302 may not need to notify the Rx node 304 regarding the predefined parameters of the chirp signals 330 as such parameters may have been known by the Rx node 304 (for example, according to the specification of the one or more communication standards).

Below are examples of the parameters of a chirp signal 330 that may be predefined and/or configured by the Tx node 302:
the bandwidth BW_{c} of a chirp signal 330;
the starting frequency fₛₜₐᵣₜ of the chirp signal 330;
the ending frequency f_{end} of the chirp signal 330; and/or
the slope (that is, the chirp rate u₀) of the chirp signal 330.

For example, in some embodiments, the entire carrier bandwidth may be pre-defined or configured for sensing using, for example, one or more chirp signals. In these embodiments, the Tx node 302 may not need to configure the starting frequencies fₛₜₐᵣₜ of the chirp signals 330. As another example, in some embodiments, the starting frequencies fₛₜₐᵣₜ of the chirp signal 330 are pre-defined as the lowest frequency of the carrier. In these embodiments, the Tx node 302 may not need to configure the starting frequencies fₛₜₐᵣₜ of the chirp signals 330.

As yet another example, in the example shown in FIG. 8C, the sensing symbol 322 comprises two chirp signals 330 multiplexed in time. The Tx node 302 may individually configure the bandwidth BW_{c}, the starting or ending frequency fₛₜₐᵣₜ or f_{end}, slope u₀, and/or the starting or ending time locations (that is, the starting or ending time instants) of each chirp signal 330. Alternatively, the Tx node 302 may configure a same set of the slope u₀, and/or the starting/ending frequency fₛₜₐᵣₜ or f_{end} for both chirps, and individually configure the starting or ending time locations of each chirp signal 330. As another example, when there are multiple chirp signals multiplexed in frequency (see, for example, FIG. 8B), a TRP 102 may configure the starting frequency f0A of the first chirp signal 330A, the starting frequency f1A of the second chirp signal 330B is pre-defined as the ending frequency f0B of the first chirp signal 330A.

With above-described parameters, the sensing symbols 322 and communication symbols 320 are aligned in time. More specifically, when the sensing symbols 322 and communication symbols 320 are multiplexed (and aligned) in frequency, the starting time-boundary of a sensing symbol 322 is aligned with (that is, the same as) the starting time-boundary of a communication symbol 320, and/or the ending time-boundary of a sensing symbol 322 is aligned with (that is, the same as) the ending time-boundary of a communication symbol 320. When the sensing symbols 322 and communication symbols 320 are multiplexed in time, the starting time-boundary of a sensing symbol 322 is aligned with (that is, the same as) the ending time-boundary of the previous communication symbol 320, and/or the ending time-boundary of a sensing symbol 322 is aligned with (that is, the same as) the starting time-boundary of the next communication symbol 320.

In some embodiments following 5G NR or similar standards, the communication symbols 320 are OFDM symbols. FIG. 9 is a frequency-time diagram showing an example of the SAC signal 312 using OFDM symbols as the communication symbols 320.

Each OFDM symbol 320 comprises an information part 342 having a plurality of information items 344 (such as data items) arranged in a plurality of subcarriers. The information items 344 are converted to a time-domain signal by using, for example, the inverse fast Fourier transform (IFFT), and then a tail portion of the time-domain signal is copied to the front thereof as the cyclic prefix (CP) 346 for combating channel distortion. Thus, the time duration Tₛ of the OFDM symbol 320 is the total time duration of the CP 346 and the information part 342, and the starting time-boundary of the OFDM symbol 320 is the starting time-boundary of the CP 346 thereof.

The sensing symbols 322 and communication symbols 320 are multiplexed in time and have the same time duration. Therefore, the starting time-boundary of a sensing symbol 322 is aligned in time with the ending time-boundary of the previous communication symbol 320, and/or the ending time-boundary of a sensing symbol 322 is aligned in time with the starting time-boundary of the next communication symbol 320.

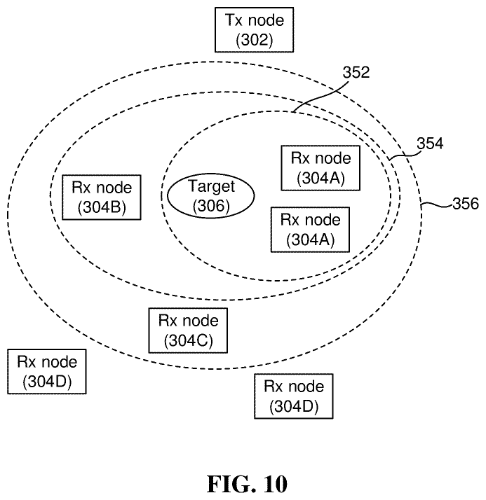

As shown in FIG. 10, the Rx nodes 304 may be classified into various cooperating sets such as:
a sensing transceiving set 352,
a sensing active set 354, and
a sensing cooperating set 356.

The sensing cooperating set 356 includes one or more Rx nodes (such as Rx nodes 304A to 304C) that are configured (for example, by a TRP 102) for sensing cooperating. Some nodes (such as nodes 304A and 304B) in the sensing cooperating set 356 may have completed the initial access procedure, but some other nodes (such as nodes 304C) in the sensing cooperating set 356 may not. A node in the sensing cooperating set 356 may be denoted a sensing cooperating node.

The sensing active set 354 includes one or more Rx nodes (such as Rx nodes 304A and 304B) in the sensing cooperating set 356 that are activated (for example, by a TRP 102) for sensing. On the other hand, if a Rx node 304 in the sensing active set 354 is deactivated, it is removed from the sensing active set 354 but still belongs to the sensing cooperating set 356. A node in the sensing active set 354 may be denoted a sensing active node.

The sensing transceiving set 352 includes one or more Rx nodes (such as Rx nodes 304A) in the sensing active set 354 that are configured to actively receive sensing signal for a predefined or configured time period. Optionally, after receiving a sensing signal, the Rx node 304 in the sensing transceiving set 352 may send its measurement results of the received sensing signal to the Tx node 302, a TRP 102, or another node for sensing result processing. A TRP 102 may configure which Rx nodes 304 in the sensing active set 354 may be configured as Rx nodes in the sensing transceiving set 352. For example, the sensing active set 354 may comprise N Rx nodes 304. Then, a bitmap indication of N bits may be used to indicate which Rx nodes belong to the sensing transceiving set 352, with value of binary one (1) meaning “belonging to” and value of binary zero (0) meaning “not belonging to”. A node in the sensing transceiving set 352 may be denoted a sensing transceiving node.

Thus, the sensing transceiving set 352 may be a subset of the sensing active set 354, and the sensing active set 354 (including the sensing transceiving set 352) may be a subset of the sensing cooperating set 356. In other words, the Rx nodes in the sensing cooperating set 356 are candidates for sensing receiving. When a Rx node 304 in the sensing cooperating set 356 is activated, for example, by a TRP 102 or a Tx node 302, it becomes a Rx node in the sensing active set 354. When a Rx node 304 in the sensing active set 354 completes the sensing-transceiving determination procedure (described in more detail later) and/or is configured by a TRP 102 or a Tx node 302, it becomes a node in the sensing transceiving set 352.

As shown in FIG. 10, the communication system 100 may also include some Rx nodes 304D that are not configured for sensing cooperating (denoted “non-cooperative Rx nodes”).

For ease of illustration, FIG. 10 only shows a single Tx node 302. However, those skilled in the art will appreciate that the communication system 100 may comprise a plurality of Tx nodes 302.

In some embodiments, a Tx node 302 (such as a TRP 102) may configure the sensing cooperating set 356 and the sensing active set 354 (that is, deciding on which Rx node 304 shall be included in the sensing cooperating set 356 and which Rx node 304 shall be included in the sensing active set 354).

In some other embodiments, a Tx node 302 (such as a TRP 102) may only configure the sensing active set 354. In these embodiments, other suitable methods may be used for configuring the sensing cooperating set 356. For example, a Rx node may be predefined as a cooperative Rx node (which will then be included in the sensing cooperating set 356) or a non-cooperative Rx node (which will then not be included in from the sensing cooperating set 356) based on its capacity, type, manufacture, and/or the like.

Due to the random reflection nature of wireless signals, not all Rx nodes in the sensing active set 354 may receive the echo of a SAC signal. Therefore, the Tx node 302 may execute a sensing-transceiving determination procedure to determine which Rx nodes in the sensing active set 354 shall be included into the sensing transceiving set 352.

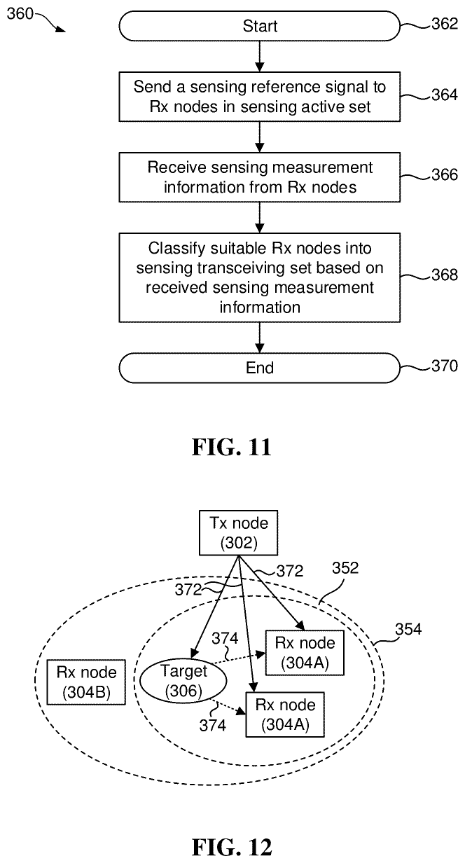

FIG. 11 is a flowchart showing a sensing-transceiving determination procedure 360 performed by the Tx node 302, according to some embodiments of this disclosure. FIG. 12 shows an example of the sensing-transceiving determination procedure 360 (the direct SAC signal transmissions from the Tx node 302 to the Rx nodes 304A and 304B are not shown).

With reference to FIGS. 11 and 12, after the procedure starts (step 362), the Tx node 302 sends a sensing reference signal 372 (such as a SAC signal 240) to Rx nodes 304A and 304B in the sensing active set 354 (step 364). In some embodiments, the sensing reference signal 372 may comprise an automatic gain control (AGC) signal (or one or more AGC symbols), which may be used for both AGC setting and cooperation node discovery. Each Rx node 304A receives and measures the sensing reference signal 372 and/or the echo 374 thereof (representatively denoted “the sensing reference signal 372”), and reports to the Tx node 302 the sensing measurement information, for example, the power of the sensing reference signal 372.

In some embodiments, if a Rx node 304B does not detect the sensing reference signal 372, it reports an indication of non-detection (for example, zero (o) or NACK) to the Tx node 302. Alternatively, the Rx node 304B may not report the indication of non-detection if it does not detect the sensing reference signal 372. Those skilled in the art will appreciate that, in various embodiments, any suitable criteria may be used to determine the non-detection of the sensing reference signal 372. For example, in some embodiments, the detection of the sensing reference signal 372 of any power level may be considered a detection of the sensing reference signal 372, and thus, “non-detection” only occurs when the sensing reference signal 372 is not detected at all. In some embodiments, if the sensing reference signal 372 is not detected at all, or if the sensing reference signal 372 is detected but the power of the detected sensing reference signal 372 is lower than a predefined or configured power threshold, non-detection of the sensing reference signal 372 occurs. The Rx node 304B may then report zero (o) or NACK to the Tx node 302. Alternatively, the Rx node 304B may not report the indication of non-detection.

In some embodiments, the Rx node 304B may report to the Tx node 302 an indication of detection as the sensing measurement information if the sensing reference signal 372 is detected with a power thereof greater than a predefined or configured power threshold. In these embodiments, the Rx node 304B may report to the Tx node 302 an indication of non-detection (such as zero (o) or NACK) if the sensing reference signal 372 is not detected at all, or if the sensing reference signal 372 is detected but the power of the detected sensing reference signal 372 is lower than the predefined or configured power threshold, or alternatively may not report any indication of non-detection.

The Tx node 302 receives the sensing measurement information from the Rx nodes 304A in the sensing active set 354 (step 366). Based on the received sensing measurement information, the Tx node 302 or a TRP 102 then configures suitable Rx nodes (such as the Rx nodes 304A that report sensing measurements greater than a predefined threshold) into the sensing transceiving set 352, and notifies each of these Rx nodes 304A that it is included in the sensing transceiving set 352 (step 368). The procedure 360 then ends (step 370).

The Rx nodes 304A classified into in the sensing transceiving set 352 then actively participate in the cooperative sensing, that is, receive the SAC signal and/or the echo thereof, and report the sensing results to the Tx node 302 according to a cooperative sensing procedure.

When a Rx node 304A in the sensing transceiving set 352 is no longer able to receive the echo of the SAC signal (for example, due to its movement), or a Rx node 304A requests to stop cooperative sensing (for example, due to its power saving requirement), the Tx node 302 may de-activate the Rx node 304A from cooperative sensing (that is, removing it from the sensing transceiving set 352) by removing the Rx node 304A from the sensing transceiving set 352. As a result, the de-activated Rx node 304 does not participate the cooperative sensing and does not measurement and report the sensing result.

By using the sensing transceiving set 352, only a subset of Rx nodes 304 perform measurement and report the measurements to the Tx node 302, thereby reducing the air interface overhead compared to the embodiments wherein all nodes participate the cooperative sensing procedure.

In some embodiments, the SAC signal may be a sensing burst set comprising a plurality SAC signal components, such as a plurality of sensing beams, transmitted by the Tx node 302 within a time window of sensing transmission. In various embodiments, the length of the time window may be pre-defined or customized by the Tx node 302.

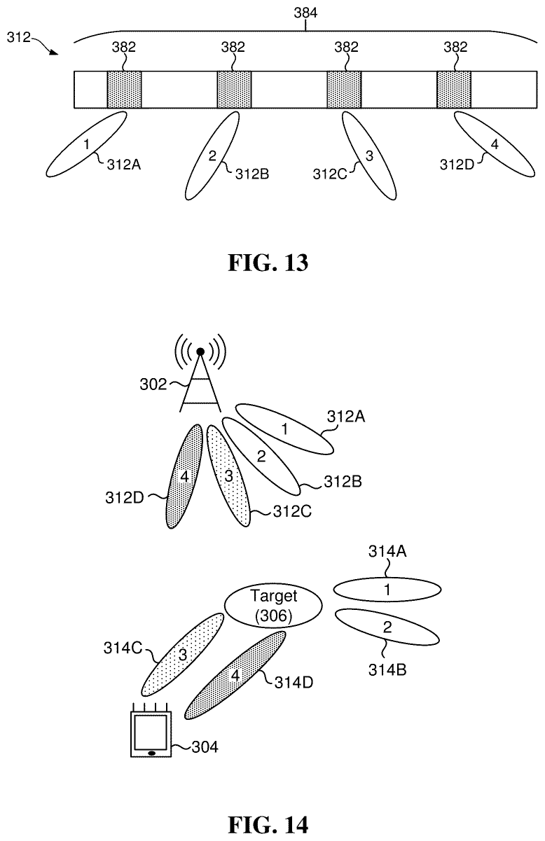

FIG. 13 is a schematic diagram showing an example of a SAC signal 312 in the form of sensing burst set and comprising four sensing beams 312A to 312D transmitted by the Tx node 302 (not shown) at different time slots 382 of a time window 384, each sensing beam towards a specific direction such that the sensing burst set 312 may cover a wide angular span. In some embodiments, the sensing beams 312A to 312D may be indexed.

As those skilled in the art will appreciate, a Rx node 304 may not receive the echoes of all sensing beams 312A to 312D. In the example shown in FIG. 14 (wherein the direct SAC signal transmission from the Tx node 302 to the Rx node 304 is not shown), a Rx node 304 (such as a UE 114) may only receive the echoes 314C and 314D of the sensing beams 312C and 312D, respectively, and may not receive the echoes 314A and 314B of the sensing beams 312A and 312B, respectively.

In some embodiments, the Rx node 304 may use an on-demand cooperative sensing reporting method to only report the measurement results of the beam-echoes 314C and 314D that it receives (rather than information of all beam-echoes 314) so as to reduce the reporting overhead.

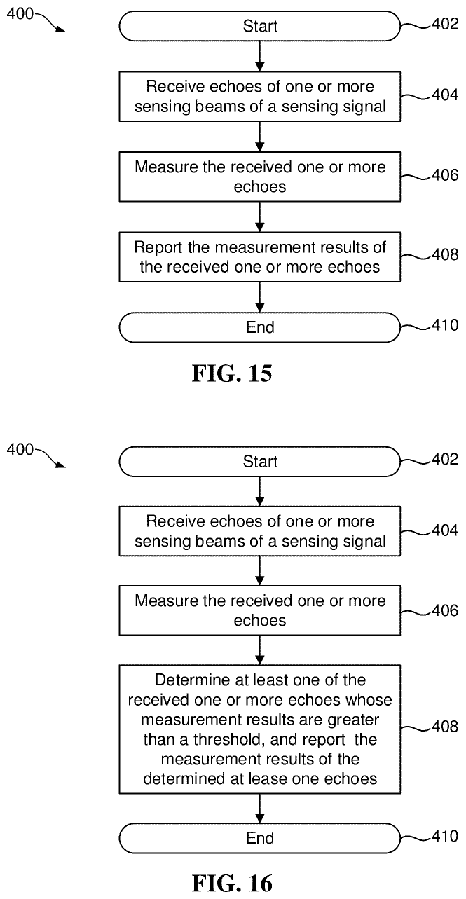

FIG. 15 is a flowchart showing an on-demand cooperative sensing reporting procedure 400 executed by the Rx node 304 for on-demanding cooperative sensing reporting, according to some embodiments of this disclosure.

Also referring to FIG. 14, after the procedure 400 starts (step 402), the Rx node 304 receives the echoes 314C and 314D of one or more sensing beams 312C and 312D of a SAC signal 312 transmitted from the Tx node 302 (step 404). The Rx node 304 measures the received one or more echoes 314C and 314D (step 406), and reports the measurement results and beam information of the received one or more echoes 314C and 314D to the Tx node 302 (step 408). The procedure 400 then ends (step 410).

At step 408, the Rx node 304 may report any suitable beam information of the received one or more echoes 314C and 314D to allow the Tx node 302 understand which echoes the Rx node 304 has received. In some embodiments, the Rx node 304 may report the time information of the received one or more echoes 314C and 314D.

For example, in some embodiments, the SAC signal 312 may be partitioned into a plurality of frames each having a predefined duration (such as 10 milliseconds (ms)). Each frame is partitioned into a plurality of subframes (such as 10 subframes of one (1) ms). Each subframe is partitioned into a plurality of slots according to a numerology. Each slot comprises a predefined number of OFDM and/or sensing symbols 320 and 322 (such as 14 OFDM and/or sensing symbols 320 and 322 if normal CPs are used, or 12 OFDM and/or sensing symbols 320 and 322 if extended CPs are used).

In these embodiments, the Rx node 304 may report the time locations of the received one or more echoes 314C and 314D such as the time slots 382 (see FIG. 13) and/or the symbol indices of the sensing symbols of the corresponding sensing beams 312C and 312D.

As another example, in some embodiments where the sensing beams 312A to 312D are indexed, the Rx node 304 may report the beam indices of the corresponding sensing beams 312C and 312D.

As yet another example, in some embodiments, the Rx node 304 may report the sequence number (such as the third and fourth transmissions) of the corresponding sensing beams 312C and 312D in the sensing burst set.

FIG. 16 is a flowchart showing an on-demand cooperative sensing reporting procedure 400 executed by the Rx node 304 for on-demanding cooperative sensing reporting, according to some other embodiments of this disclosure. The on-demand cooperative sensing reporting procedure 400 is similar to that shown in FIG. 15 except that, at step 408, the Rx node 304 compares the measurement result of each received echo 314C, 314D with a predefined power threshold, and only reports the measurement results greater than the predefined power threshold.

In some embodiments, the Rx node 304 may first report the beam information (such as the time information) of the received one or more echoes 314C and 314D to the Tx node 302. The Tx node 302 allocates the reporting resource for the Rx node 304 based on received beam information report, and notifies the Rx node 304 via suitable signaling. The Rx node 304 then uses the allocated reporting resource to report the sensing measurement results.

In some embodiments, the communication system 100 (or more specifically, the Tx nodes 302 and Rx nodes 304 thereof) may use distributed sensing cooperation. More specifically, a Rx node 304 may cooperate with a plurality of Tx nodes 302 for cooperative sensing, and a Tx node 302 may cooperate with a plurality of Rx nodes 304 for cooperative sensing. For ease of description, the Tx and Rx nodes 302 and 304 in distributed sensing cooperation are denoted cooperating Tx and Rx nodes.

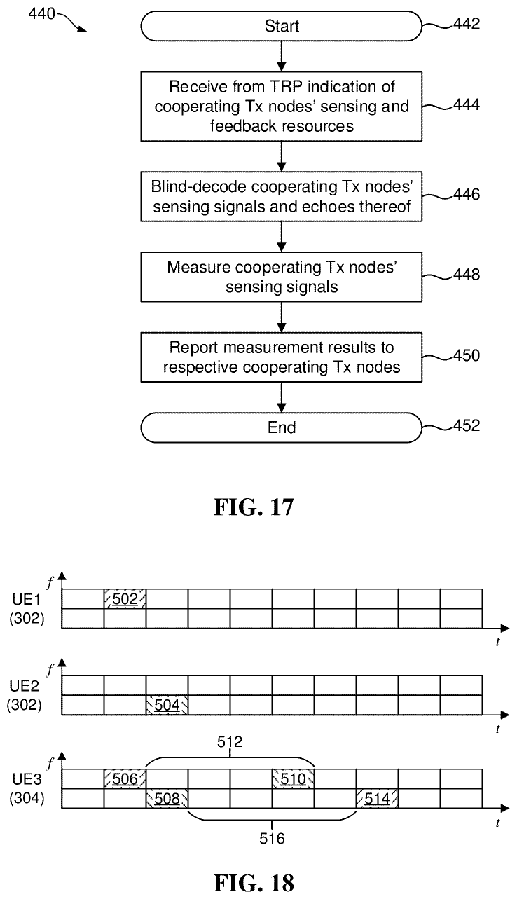

FIG. 17 is a flowchart showing a distributed sensing cooperation procedure 440 executed by a cooperating Rx node 304, according to some embodiments of this disclosure.

In these embodiments, each cooperating Tx node 302 may transmit a SAC signal using the sensing resources (such as time, frequency, spatial resource, and/or the like) assigned thereto. A TRP 102 (which may be a Tx node 302, a Rx node 304, or a different node) may send the cooperating Rx node 304 an indication of the sensing resources of a plurality of cooperating Tx nodes 302. The TRP 102 may also send the cooperating Rx node 304 an indication of the resources for feedback (including time-domain feedback resources).

After the distributed sensing cooperation procedure 440 starts (step 442), the cooperating Rx node 304 receives from TRP 102 the indications of the sensing resources and feedback resources associated with the plurality of cooperating Tx nodes 302 (step 444).

At step 446, based on the received indication, the Rx node 304 receives and blind-decodes the SAC signals of at least some cooperating Tx nodes 302 and/or the echoes thereof (as described above, the Rx node 304 may not receive echoes of all SAC signals). The Rx node 304 also measures the received SAC signals and/or the echoes thereof (step 448).

At step 450, the cooperating Rx node 304 reports the measurement results to respective cooperating Tx nodes 302 using respective feedback resource, and the procedure ends (step 452).

In these embodiments, the cooperating Rx node 304 only reports to the cooperating Tx nodes 302 if the cooperating Rx node 304 receives the echoes of the SAC signals thereof. In other words, the cooperating Rx node 304 does not report to a cooperating Tx node 302 if the cooperating Rx node 304 does not receive the echo of the SAC signal thereof.

As those skilled in the art will appreciate, by allocating orthogonal sensing and/or feedback resources for different cooperating Tx nodes 302, collision may be avoided when the cooperating Tx nodes 302 transmit their SAC signals and/or when the cooperating Rx node 304 reports the measurement results to a plurality of cooperating Tx nodes 302.

In some embodiments, the sensing resources may be predefined (for example, a set of predefined channels). In these embodiments, the TRP 102 does not need to send the information of the sensing resources to the Rx node 304.

In some embodiments, the feedback resources may be predefined (for example, a set of predefined channels). In these embodiments, the TRP 102 does not need to send the information of the feedback resources to the Rx node 304.

FIG. 18 is a schematic diagram showing an example of the distributed sensing cooperation. In this example, UE1 and UE2 are Tx nodes 302, and UE3 is a Rx node 304. A TRP 102 (not shown) allocates sensing resources 502 and 504 to Tx nodes UE1 and UE2, respectively. More specifically, the TRP 102 may allocate orthogonal sensing resources to Tx nodes UE1 and UE2 via, for example, frequency-division multiplexing (FDM), time-divisional multiplexing (TDM), different root index in Zadoff-Chu (ZC) sequence, same root index but different cyclic shift in ZC sequence, time-domain orthogonal cover code (OCC), frequency domain OCC, and/or the like. In the example shown in FIG. 18, the TRP 102 allocates different BWPs 502 and 504 at different frequency bands and different time slots to the Tx nodes UE1 and UE2.

The TRP 102 sends to the Rx node UE3 a notification of the allocated sensing resources of UE1 and UE2.

The TRP 102 also allocates the feedback resources to the Rx node UE3 (for sending feedbacks to the Tx nodes UE1 and UE2), and sends the Rx node UE3 a notification of the allocated feedback resources.

When the Rx node UE3 is configured to detect N Tx nodes 302 (N=2 in the example shown in FIG. 18), N orthogonal feedback resources are allocated to the Rx node UE3, where each feedback resource is associated with a Tx node 302. In the example shown in FIG. 18, feedback resource 510 is associated with the Tx node UE1, and feedback resource 514 is associated with the Tx node UE2.

Similar to the allocation of the orthogonal sensing resources, the TRP 102 may allocate orthogonal feedback resources to Tx nodes UE1 and UE2 via, for example, FDM, TDM, different root index in Zadoff-Chu (ZC) sequence (that is, the root index is unique among the root indices of the feedback resources), same root index but different cyclic shift in ZC sequence (that is, the cyclic shift is unique among the cyclic shifts of the feedback resources), time-domain OCC, frequency domain OCC, and/or the like. Moreover, each feedback resource may comprise a timing offset (described in more detail later). Depending on the implementation, the timing offsets of different feedback resources may be different or the same.

In the example shown in FIG. 18, the Rx node UE3 receives UE1's SAC signal and/or the echo thereof at time slot 506, and receives UE2's SAC signal and/or the echo thereof at time slot 508. With the received notification of the allocated sensing resources of the Tx nodes UE1 and UE2, the Rx node UE3 may blind-detect the SAC signals transmitted from the Tx nodes UE1 and UE2 and/or the echoes thereof. Since the sensing resources of the Tx nodes UE1 and UE2 are orthogonal, the Rx node UE3 may determine the transmitter of each received SAC signal (that is, being UE1 or UE2).

The Rx node UE3 measure the received SAC signals and/or the echoes thereof. Then, the Rx node UE3 uses the feedback resource 510 (which is at the allocated frequency band and is at the allocated timing offset 512 from the corresponding receiving time slot 506) to report to the Tx node UE1 the sensing measurement results of UE1's SAC signal and/or the echo thereof, and uses the feedback resource 514 (which is at the allocated frequency band and is at the allocated timing offset 516 from the corresponding receiving time slot 508) to report to the Tx node UE2 the sensing measurement results of UE2's SAC signal and/or the echo thereof.

In some embodiments, the cooperative sensing method may also facilitate a Rx node 304 to alleviate or even avoid the burden and/or latency of beam sweeping.

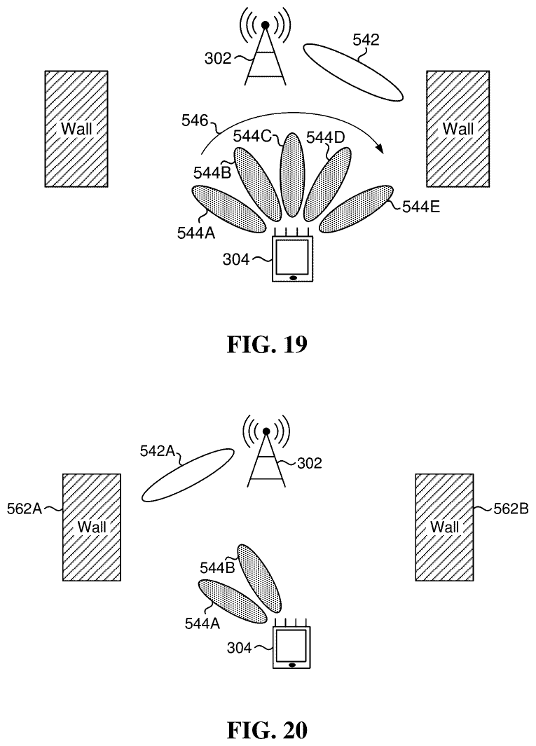

FIG. 19 is a schematic diagram showing the conventional beam sweeping. As shown, a Tx node 302 such as a TRP 102 transmits a signal beam 542 for data communication. The Rx node 304 (such as a UE 114) may use a plurality of receiving beams 544 towards a plurality of directions (that is, focusing on signal receiving on the plurality of directions) to receive the signal beam 542. Alternatively, the Rx node 304 may use a single receiving beam 544 and turning the direction of the receiving beam 544 as indicated by the arrow 546 to receive the signal beam 542. Generally, the Rx node 304 needs to use beam sweeping (for example, using multiple receiving beams or turning the direction of a single receiving beam) to cover a wide angular span.

In some embodiments of this disclosure, a Tx node 302 (such as a TRP 102) may, based on its knowledge of the environment, send information of candidate receiving beams (corresponding to or otherwise associated with the sensing beam transmitted from the Tx node 302) to a Rx node 304 (such as a UE 114) such that the Rx node 304 may only form a reduced number of receiving beams or sweep a reduced angular span.

FIG. 20 shows an example of using candidate receiving beams to alleviate beam sweeping. As shown, the Tx node 302 may gain knowledge of the environment (such as the location of the walls 562A and 562B) from previous sensing (for example, via sensing fusion at the Tx-node side) or based on a predefined knowledge (such as a site map). In this example, the Tx node 302 transmits a sensing beam 542A towards the wall 562A. Based on the knowledge of the environment and the direction of the transmitted sensing beam 542A, the Tx node 302 determines that the Rx node 304 would likely, or be capable to, receive the echo of the sensing beam 542A along the directions of the receiving beams 544A and 544B, but would likely unable to receive the echo of the sensing beam 542A along the directions of the receiving beams 544C to 544E. Therefore, the Tx node 302 may send to a Rx node 304 the information of candidate receiving beams 544A and 544B (for example, in the form of {Tx beam 542A, [Rx beam 544A, Rx beam 544B]}) for receiving the echo of the sensing beam 542A.

Then, the Rx node 304 may only form two receiving beams 544A and 544B or use a single receiving beam to sweep the reduced angular span corresponding to the candidate receiving beams 544A and 544B, for receiving the echo of the sensing beam 542A.

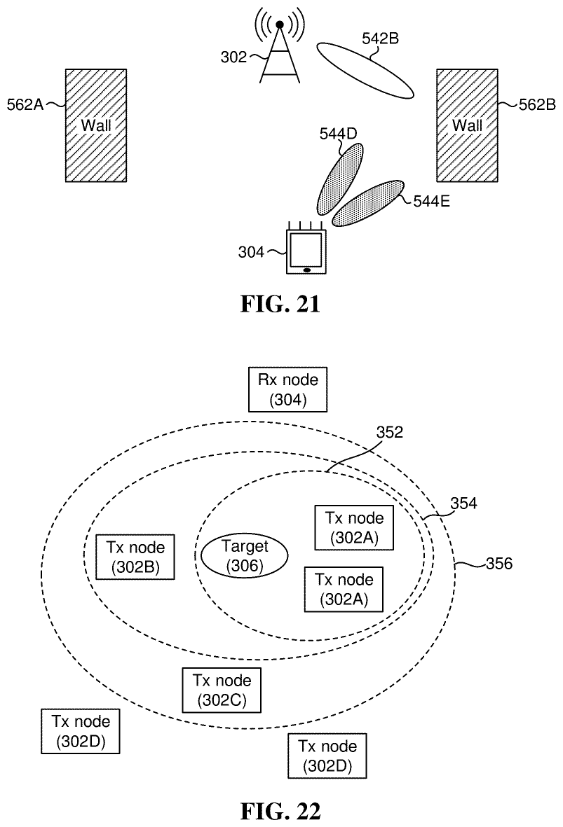

Similarly, in the example shown in FIG. 21, the Tx node 302 transmits a sensing beam 542B towards the wall 562B. Based on the knowledge of the environment and the direction of the transmitted sensing beam 542B, the Tx node 302 may send to a Rx node 304 the information of candidate receiving beams 544D and 544E {Tx beam 542B, [Rx beam 544D, Rx beam 544E]}) for receiving the echo of the sensing beam 542B.

Then, the Rx node 304 may only form two receiving beams 544D and 544E or use a single receiving beam to sweep the reduced angular span corresponding to the candidate receiving beams 544D and 544E, for receiving the echo of the sensing beam 542B.

Thus, by using the candidate receiving beams, the Rx node 304 may perform reduced number of beam sweeping, thereby reducing the latency and/or the air interface overhead.

Those skilled in the art will appreciate that other embodiments and variations are readily available. For example, in some embodiments, one may selectively use some features of above-described embodiments when feasible and as desired or needed, or may selectively combine various features of above-described embodiments when feasible and as desired or needed.

In above embodiments, a Tx node 302 sends the sensing reference signal to a Rx node 304 for determining whether the Rx node 304 shall be included in the sensing transceiving set 352 based on the measurement conducted by and fed back from the Rx node 304. In some embodiments, the Rx node 304 determines whether itself shall be included in the sensing transceiving set 352 based on its measurement, and notifies the Tx node 302.

In above embodiments, the Rx nodes 304 are classified into various cooperating sets such as a sensing transceiving set 352, a sensing active set 354, and a sensing cooperating set 356. In some embodiments, the Tx nodes 302 may alternatively or also be classified into various cooperating sets (for example, similar to the above-described cooperating sets). For example, FIG. 22 shows a plurality of Tx nodes 302 cooperating with a Rx node 304 for sensing. The plurality of Tx nodes 302 may be classified into various cooperating sets such as a sensing transceiving set 352, a sensing active set 354, and a sensing cooperating set 356 in a manner similar to that described above, and the operations and configurations described above may also be applied in these embodiments in a similar manner. In some embodiments, a Tx node 302 may send a sensing reference signal to the Rx nodes 304 in the sensing transceiving set 352, and receive the measurements therefrom. If the measurements received from one or more of the Rx nodes 304 (which may be one or more specific Rx nodes 304 (determined by, for example, the IDs thereof) or any predefined number of Rx nodes 304 in the sensing transceiving set 352) are smaller than a predefined threshold, the Tx node 302 may exclude itself from the sensing transceiving set 352; otherwise, the Tx node 302 may include itself into the sensing transceiving set 352. Alternatively, a TRP 102 may configure a Tx node 302 into the sensing transceiving set 352, the sensing active set 354, or the sensing cooperating set 356.

In above embodiments, the communication system 100 is a mobile communication system having terrestrial communication networks and/or non-terrestrial communication networks, such as a combination of cellular networks and satellite communication networks. In some embodiments, the communication system 100 may comprise, or alternatively be, other RANs such as WI-FI® networks (WI-FI is a registered trademark of Wi-Fi Alliance, Austin, TX, USA).

In above embodiments, a Rx node 304 detects a SAC signal and an echo thereof for detecting an object that reflects the echo and determining parameters of the object. In some embodiments, the Rx node 304 may also use the detected SAC signal for determining parameters of the Rx node 304 itself. In some embodiments, a Rx node 304 may not detect any echo of a SAC signal and therefore may only determining parameters of the Rx node 304 itself. The above description may be applicable to the Rx node 304 in these embodiments, except that any of above description related to echoes shall be considered related to the SAC signal.

In above embodiments, the sensing symbol 322 comprises one or more sensing signals such as one or more chirp signals 330. In some other embodiments, the sensing symbol 322 may comprise other types of sensing signals such as pulses, unmodulated continuous waves, frequency modulated continuous waves, OFDM signals, and/or the like.

As described above, in some embodiments, one or more Tx nodes 302 and one or more Rx nodes 304 may use cooperative sensing for detecting one or more objects using one or more SAC signals 312. In some other embodiments, a communication node may transmit a SAC signal 312 and receive an echo thereof for detecting an object.

In above description where it is described that a Tx node 302 may perform a configuration, those skilled in the art will appreciate that, instead of letting the Tx node 302 to perform the configuration, a TRP 102 (which may or may not be a Tx node 302) may perform the configuration, and may notify the Tx nodes 302 and/or the Rx nodes 304 as needed. Alternatively or in addition, a Rx node 304 may perform the configuration, and may notify the Tx nodes 302 and/or the TRP 102 as needed.

Herein, various embodiments of cooperative sensing methods for integrated sensing and communication are described. In some embodiments, the cooperative sensing methods disclosed herein may be implemented as one or more circuits (such as one or more processing units, or one or more processors) of a module, a device, an apparatus, a system, and/or the like. In some embodiments, the cooperative sensing methods disclosed herein may be implemented as computer-executable instructions stored in one or more non-transitory computer-readable storage devices such that, the instructions, when executed, may cause one or more circuits (such as one or more processing units, or one or more processors) to perform the cooperative sensing methods disclosed herein. The technical features and benefits of above-described embodiments may include:
By partitioning the Rx and/or Tx nodes to various cooperating sets 352 to 356, and by using the sensing transceiving set 352, only a subset of Rx nodes 304 perform measurement and report the measurements to the Tx node 302, thereby reducing the air interface overhead compared to the embodiments wherein all nodes participate the cooperative sensing procedure.
By transmitting from the Tx node 302 to the Rx nodes 304 in the sensing active set 354 a sensing reference signal comprising one or more AGC symbols, both AGC setting and cooperation node discovery may be achieved.
By allowing Rx nodes 304 selectively reporting the sensing measurement information (such as the power of the received echo signals), Rx nodes 304 may use the on-demand cooperative sensing report method to only report the information regarding the echo signals or echo signal beams it has received and does not need to report the information regarding all SAC signals or SAC signal beams. The Rx nodes 304 may use a receiving power threshold for determining which echo signals/beams shall be reported and which shall not.
By using a sensing burst set of Tx sensing beams and by reporting from a Rx node 304 the time locations of received echoes (for example, corresponding to Tx beam indices), the Tx node 302 may obtain the time locations of the sensing measurements reported from the Rx node 304, and derive the correct sensing results.
By using distributed sensing cooperation, a Rx node 304 may facilitate a plurality of Tx nodes 302 in their sensing.
By allocating orthogonal sensing resources and feedback resources in distributed sensing cooperation, collision may be avoided. The use of timing offsets in feedback further ensures collision avoidance.
By using candidate Rx beams, latency and/or air interface overhead may be reduced.

Those skilled in the art will appreciate that the above-described embodiments and/or features thereof may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method comprising:
determining a type of a first communication node for object sensing; and
notifying the first communication node of the determined type;
wherein determining the type of the first communication node comprises:
determining the type of the first communication node as a sensing transceiving node in a sensing transceiving set to receive or transmit a sensing signal for object sensing, or
determining the type of the first communication node as a sensing active node in a sensing active set, the sensing active set comprising the sensing transceiving set.

2. The method of claim 1, wherein determining the type of the first communication node comprises:
determining the type of the first communication node as the sensing transceiving node in the sensing transceiving set;
determining the type of the first communication node as the sensing active node in the sensing active set; or
determining the type of the first communication node as a sensing cooperative node in a sensing cooperative set, the sensing cooperative set comprising the sensing active set.

3. The method of claim 2, wherein the first communication node is the sensing cooperating node; and
wherein determining the type of the first communication node comprises:
activating the first communication node to become the sensing active node.

4. The method of claim 2, wherein the first communication node is the sensing active node, and
wherein determining the type of the first communication node comprises:
deactivating the first communication node to become the sensing cooperating node.

5. The method of claim 1, wherein the first communication node is the sensing active node; and
wherein determining the type of the first communication node comprises:
determining the type of the first communication node as the sensing transceiving node in the sensing transceiving set based on an instruction of a transmit-and-receive point (TRP).

6. The method of claim 1, wherein the first communication node is the sensing active node; and
wherein determining the type of the first communication node comprises:
determining, based on information of a measurement of a sensing reference signal, the type of the first communication node as the sensing transceiving node in the sensing transceiving set.

7. The method of claim 6, wherein the sensing reference signal comprises one or more automatic gain control (AGC) symbols.

8. The method of claim 6, wherein the measurement of the sensing reference signal comprises a power measurement of the sensing reference signal.

9. The method of claim 6, wherein determining the type of the first communication node further comprises:
transmitting the sensing reference signal to the first communication node; and
receiving the information of the measurement of the sensing reference signal from the first communication node.

10. The method of claim 9, wherein determining, based on the information of the measurement of the sensing reference signal, the type of the first communication node as the sensing transceiving node in the sensing transceiving set comprises:
determining the type of the first communication node as the sensing transceiving node in the sensing transceiving set when a power measurement of the sensing reference signal is greater than a power threshold.

11. The method of claim 9, wherein determining, based on the information of the measurement of the sensing reference signal, the type of the first communication node as the sensing transceiving node in the sensing transceiving set comprises:
determining the type of the first communication node as the sensing transceiving node in the sensing transceiving set when the information of the measurement of the sensing reference signal comprises an indication of detection.

12. The method of claim 6, wherein determining the type of the first communication node further comprises:
receiving the sensing reference signal from the first communication node; and
determining the information of the measurement of the sensing reference signal.

13. The method of claim 1, further comprising:
transmitting a sensing signal, the sensing signal comprising a plurality of beams directing towards different directions; and
wherein transmitting the sensing signal comprises:
transmitting the plurality of beams at different time slots of a time window.

14. The method of claim 13, further comprising:
determining, from the plurality of beams, one or more beams that the first communication node is capable to receive; and
sending the first communication node a notification regarding the determined one or more beams.

15. A method comprising:
receiving a plurality of signal beams transmitted from a transmitter (Tx) node;
measuring the received plurality of signal beams to obtain measurement results of the received plurality of signal beams; and
reporting, based on the measurement results, beam information or a measurement result of at least one of the received plurality of signal beams.

16. The method of claim 15, wherein the beam information of the at least one of the received plurality of signal beams comprises time information of the at least one of the received plurality of signal beams.

17. The method of claim 16, wherein the time information of the at least one of the received plurality of signal beams comprises at least one of:
a time slot of each of the at least one of the received plurality of signal beams;
one or more symbol indices of one or more sensing symbols of each of the at least one of the received plurality of signal beams;
a beam index of each of the at least one of the received plurality of signal beams; or
a sequence number of each of the at least one of the received plurality of signal beams.

18. The method of claim 15, wherein reporting, based on the measurement results, the beam information or the measurement result of the at least one of the received plurality of signal beams comprises:
reporting the beam information or the measurement result of the at least one of the received plurality of signal beams having a measured power greater than a power threshold.

19. The method of claim 15 further comprising:
receiving indications of a sensing resource and a feedback resource associated with the Tx node;
wherein receiving the plurality of signal beams transmitted from the Tx node comprises:
receiving the plurality of signal beams transmitted from the Tx node using the sensing resource; and
wherein reporting, based on the measurement results, the beam information or the measurement result of the at least one of the received plurality of signal beams comprises:
reporting, based on the measurement results, the beam information or the measurement result of the at least one of the received plurality of signal beams using the feedback resource.

20. The method of claim 19, wherein at least one of the sensing resource and the feedback resource is a resource of frequency-division multiplexing (FDM), a resource of time-division multiplexing (TDM), a resource with a unique root index in a Zadoff-Chu (ZC) sequence, a resource with a root index and a unique cyclic shift in a ZC sequence, a resource with time-domain orthogonal cover code (OCC), a frequency domain OCC, or a unique timing offset.
